(19) United States
(12) Patent Application Publication
(10) Pub. No.: US 2024/0156090 A1
(43) Pub. Date: May 16, 2024

(54) SUSPENSION CONCENTRATE ACYLHYDRAZONE APYRASE INHIBITOR FORMULATION

(71) Applicant: Texas Crop Science, Austin, TX (US)

(72) Inventors: Jeffrey D. Fowler, Austin, TX (US); Simon Hiebert, Austin, TX (US)

(21) Appl. No.: 18/382,419

(22) Filed: Oct. 20, 2023

Related U.S. Application Data
(60) Provisional application No. 63/417,917, filed on Oct. 20, 2022.

(51) Int. Cl. A01N 37/28; A01N 25/04; A01N 25/22; A01N 43/54; A01N 43/56; A01N 43/653; A01P 3/00

(52) U.S. Cl. CPC A01N 37/28; A01N 25/04; A01N 25/22; A01N 43/54; A01N 43/56; A01N 43/653; A01P 3/00

(57) ABSTRACT

The disclosure concerns a formulation comprising an aqueous suspension of a first active compound having a structure

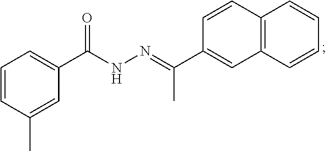 [SMILES: C/C(=N\NC(=O)c1cccc(C)c1)c1ccc2ccccc2c1]

and a dispersant, a freezing point depressant, and a buffer or partially neutralized base, such that the pH of the formulation is from about 6 to 11. The formulation comprises particles of the first active compound having a volume-weighted median particle size, as measured by light scattering, of from greater than 0.01 to 20 microns. The formulation may also comprise a viscosity modifier, biocide, antifoam, surfactant, and/or an agriculturally active compound, such as a an acaricide, antimicrobial, fungicide, herbicide, insecticide, molluscicide, or nematocide, or a combination thereof. Also disclosed are agricultural compositions comprising the formulation and methods of using the same.

### CROSS REFERENCE TO RELATED APPLICATION

This application claims the benefit of the earlier filing date of U.S. provisional patent application No. 63/417,917, filed Oct. 20, 2022, which is incorporated herein by reference in its entirety.

### FIELD

The present disclosure relates to a suspension concentrate apyrase inhibitor formulation and methods for its use, in particular in the treatment of crops susceptible to pathogens.

### BACKGROUND

Crops are plagued worldwide by a variety of pathogens. Pathogens, such as insects, mites, nematodes, weeds and fungi have developed an array of mechanisms for surviving pesticides, such as by sequestering, exporting or detoxifying them. There is a need for formulations to potentiate the efficacy of pesticides by blocking certain mechanisms of resistance.

### SUMMARY

Disclosed herein are embodiments of a formulation comprising an aqueous suspension of a first active compound having a structure

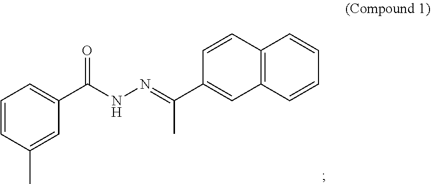 [SMILES: C/C(=N\NC(=O)c1cccc(C)c1)c1ccc2ccccc2c1]

and a dispersant, a freezing point depressant, and a buffer or partially neutralized base, such that the pH of the formulation is from about 6 to 11. The formulation comprises particles of the first active compound having a volume-weighted median particle size, as measured by light scattering, of from greater than 0.01 to 20 microns. The formulation may also comprise a viscosity modifier, biocide, antifoam, surfactant, and/or an agriculturally active compound, such as a an acaricide, antimicrobial, fungicide, herbicide, insecticide, molluscicide, or nematocide, or a combination thereof.

Also disclosed herein are embodiments of an agricultural composition suitable for an agricultural application. The agricultural composition comprises water and the disclosed formulation, and also contains an agriculturally active compound. The agriculturally active compound may be provided by the disclosed formulation, or it may be added to the agricultural composition in addition to the formulation, or a combination thereof.

Further disclosed are methods for using the formulation, or an agricultural composition comprising the formulation, to control agricultural pathogens, such as fungi.

The foregoing and other objects, features, and advantages of the disclosure will become more apparent from the following detailed description

### DETAILED DESCRIPTION

### I. Terms

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference in their entirety, unless otherwise specified.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

“Administering” refers to any suitable mode of administration, to control a pathogen, such as a fungal pathogen, including, treatment of an extant crop, agricultural produce, seeds, soil or combination thereof.

“In combination with” refers to the administration of compounds either simultaneously in a single administration, or sequentially in two or more different administrations, that may be separated either in time, location, or method.

“Control” with reference to a pathogen, such as a fungal pathogen, means block, inhibit and/or eradicate a pathogen and/or prevent the pathogen from damaging a crop. In one embodiment, control refers to the reduction of one or more pathogen, such as a fungi, to undetectable levels, or to the reduction or suppression of a pathogen to acceptable levels as determined by one of ordinary skill in the art (for example, a crop grower). Determinations of acceptable levels of pathogen reduction are based on a number of factors, including to the crop, pathogen, severity of the pathogen, use restrictions, economic thresholds and other factors known to those of ordinary skill in the art.

As used herein, the terms “enhancer” and “potentiator”, refer to a compound or compounds disclosed herein that enhance the effects of a pesticide. Without limitation to theory the present enhancer compounds disclosed herein may function by blocking one or more pathways by which a pathogen, such as a fungal pathogen, evades toxicity, such as by detoxifying, sequestering or transporting a pesticide. In certain embodiment, the present compounds inhibit enzymatic apyrase activity which leads to the enhancement, accentuation or potentiation of a pesticide, such as an acaricide, antimicrobial, fungicide, herbicide, insecticide, molluscicide and/or nematocide. For example, when the enhancer or potentiator is used in conjunction with a fungicide, the combination of the potentiator and the fungicide enhances the fungicidal effect of the fungicide and/or renders a fungus that has become resistant to the fungicide susceptible to the fungicide as a result of the activity of the potentiator. Most often, these enhancers or potentiators do not themselves inhibit the growth of a pathogen, such as a fungus, itself, nor do they have a detrimental effect on a living organism that is (or could be) infected with a pathogen.

As used herein, the term “treatment” refers to a method used to administer or apply an effective amount of a disclosed compound or formulation thereof to a target area of a field and/or plant. The treatment method can be, but is not limited to, aerosol spray, pressure spray, direct watering, chemigation, fogging, and dipping. Target areas of a plant could include, but are not limited to, the leaves, roots, stems, buds, flowers, fruit, seed of the plant, and bulbs of the plant including bulb, corm, rhizoma, stem tuber, root tuber and rhizophore. Treatment can include a method wherein a plant is treated in one area (for example, the root zone or foliage) and another area of the plant becomes protected (for example, foliage is treatment when a disclosed compound is applied in the root zone or new growth when applied to foliage).

As used herein, the term “suspension concentrate” or “SC,” refers to a liquid formulation that contains a stable suspension of active ingredient in an aqueous fluid. Suspension concentrates can be stored as a formulation, and can be provided to the market and/or end user without further processing. In practical application, suspension concentrates are prepared for application by the end user. Typically, a suspension concentrate is mixed with water in the end user's spray tank to the proper dilution for the particular application. Dilution can vary by crop, pathogen, time of year, geography, local regulations, and intensity of infection among other factors. Once properly diluted, the formulation can be applied, such as by spraying.

### II. Formulation

A common goal for the formulator of agricultural products is to maximize the biological activity of the active ingredient. In aqueous suspension concentrates this is particularly challenging because the solid state of the active ingredient tends to limit biological availability. It is, however, not generally predictable whether a particular active ingredient will have good biological activity or not when delivered as an aqueous suspension concentrate. Without being limited by a theoretical understanding, factors that can determine biological activity include the solubility in water (including how that varies with temperature, salinity and pH at the site of application), the solubility in hydrophobic domains (including within waxy leaf cuticles and any micellar surfactant domains), the crystal lattice energy, the density of the active ingredient crystals and therefore their tendency to sediment, the existence of crystal polymorphs and metastable states, the diffusivity in water, the ability of the active ingredient to diffuse through the plant cuticle, the location of the site where the active ingredient acts, and the required concentration of the active ingredient at that site. A large number of modifications are potentially discoverable by the formulator to overcome limitations in biological activity, and many of these modifications have influences that are dependent upon each other (meaning that testing each of them separately does not adequately inform about outcomes when each are varied simultaneously) and it is therefore not feasible to explore the entire experimental space.

Amongst formulations tested during work described in the present disclosure, the inventors have discovered that aqueous suspensions of (E)-3-methyl-N′-(1-(naphthalen-2-yl) ethylidene)benzohydrazide generally have poor biological activity. It has been further discovered that, with formulations containing the required components described below, the biological activity is greatly improved by controlling the particle size within a particular size range.

A common requirement for the formulator of agricultural products is to achieve acceptable stability, both in the sense of chemical stability, meaning that no significant chemical degradation occurs of the active ingredient, and also in the sense of physical stability, meaning that in commonly-available product containers stored in conditions commonly-encountered in the supply chain, the product remains in a state similar to that in which it was manufactured and the product is suitable and convenient for use by the end-user. Whether a particular active ingredient is susceptible to chemical degradation is not predictable because of the large number of factors that can determine its behavior. These include the solubility of the active ingredient in any liquid phases present (including the hydrophobic phases of any surfactant micellar structures), the presence within those liquid phases of chemical species that may catalyze degradation, any tendency for the active ingredient to undergo auto-catalysis whereby the breakdown products accelerate further reaction, the presence of chemical bonds within the active ingredient that are susceptible to cleavage and the influence of neighboring groups upon their susceptibility. Physical stability also must be assessed empirically, although it is known in the art that certain small-scale laboratory tests can often adequately represent behavior at larger scale in commercial use.

Amongst formulations tested during work described in the present disclosure, the inventors discovered that aqueous suspensions of (E)-3-methyl-N′-(1-(naphthalen-2-yl)ethylidene)benzohydrazide generally have unacceptable chemical stability. It was further discovered that, with formulations containing the required components described below, acceptable chemical stability is obtained by controlling the pH within a particular range. Additionally, it was discovered that formulations containing the required components described below have adequate physical stability and remain suitable for use even when subjected to stress testing at elevated temperatures, including temperatures that might be experienced by a commercial product during transport, storage and use.

Disclosed herein are aqueous suspension formulations comprising a first active compound, also referred to herein as, “Compound 1,” having a structure

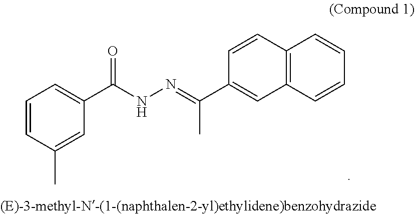 [SMILES: C/C(=N\NC(=O)c1cccc(C)c1)c1ccc2ccccc2c1]

In some embodiments, the aqueous suspension formulation further comprises a dispersant, a freezing point depressant compound, a buffer and/or partially neutralized base, and water.

In some embodiments, the aqueous suspension formulation is a suspension concentrate, suitable for dilution, such as by an end user.

In some embodiments, at least a portion of the first active compound is present as a suspension in the aqueous suspension formulation. In some embodiments, the first active compound, or a portion thereof, is the only suspended material in the aqueous suspension formulation. In other embodiments, there are additional suspended components in the formulation, in addition to the first active compound. In any embodiments, the total amount of suspended material is greater than 5 wt %, such as from greater than 5 wt % to 70 wt %, from 10 wt % to 70 wt %, from 10 wt % to 60 wt %, from 15 wt % to 60 wt %, from 15 wt % to 50 wt % or from 15 wt % to 40 wt % total suspended solid material in the formulation. In some embodiments, the additional suspended components may comprise an inert filler. Suitable fillers are fine particulate solids that do not affect biological activity and include clays, minerals, salts, diatomaceous earths, silica, alumina, cementitious materials, starch, wood flour and other natural materials such as plant-based, animal-based or microbe-based materials.

In any embodiments, the suspended particles, such as particles of the first active compound, have a volume-weighted median particle size, as measured by light scattering, of from 0.01 microns to 40 microns, such as from 0.01 microns to 30 microns, from 0.01 microns to 25 microns, from 0.01 microns to 20 microns, from 0.01 microns to 15 microns, from 0.01 microns to 10 microns, from 0.01 microns to microns, or from 0.01 microns to 2 microns, or from 1 micron to 20 microns, such as from 1 micron to microns, such as from 2 microns to 10 microns or 4 microns to 8 microns. Additionally, if the formulation includes additional suspended material, such as material disclosed herein, any such additional suspended material also may have a particle size, as measured by light scattering, as disclosed above for the first active compound.

A. First Active Compound

The aqueous suspension formulation comprises the first active compound, (E)-3-methyl-N′-(1-(naphthalen-2-yl)ethylidene)benzohydrazide, in an amount sufficient that, when diluted for use, the first active compound is present in an amount sufficient to potentiate the efficacy of one or more agricultural active compounds that may be applied in combination with the first active compound. In some embodiments, the aqueous suspension formulation comprises from 0.5 wt % to 60 wt % or more of the first active compound, such as from 1 wt % to 60 wt %, from 5 wt % to 55 wt %, from 10 wt % to 50 wt %, from 10 wt % to 45 wt % or from 15 wt % to 40 wt % of the first active compound.

In certain embodiments, the aqueous suspension formulation comprises at least 15 wt % of the first active compound, such as from 15 wt % to 60 wt %, from 15 wt % to 50 wt % or from 15 wt % to 40 wt %.

In other embodiments, the aqueous suspension formulation comprises less than 15 wt % of the first active compound, such as from 0.5 wt % to less than 15 wt %, from 1 wt % to less than 15 wt %, from 5 wt % to less than 15 wt %, or from 10 wt % to less than 15 wt %. In such embodiments, the formulation may additionally comprise additional suspended material, such as an inert filler, to bring the total amount of suspended material to at least 10 wt %, as disclosed herein.

B. Dispersant

In some embodiments, the dispersant is a high molecular weight dispersant, such as having a molecular weight of 400 Daltons or more, such as from 400 Daltons to 2,000,000 Daltons, or from 500 Daltons to 1,000,000 Daltons, from 750 Daltons to 750,000 Daltons, from 750 Daltons to 500,000 Daltons, from 1,000 Daltons to 250,000 Daltons, or from 1,000 to 100,000 Daltons.

In some embodiments, the composition comprises from 0.1 wt % to 15 wt % or more of the dispersant, such as from 0.5 wt % to 15 wt %, from 0.5 wt % to 12 wt %, or from 1 wt % to 10 wt % of the dispersant.

In any embodiments, the dispersant may be selected from anionic dispersants, cationic dispersants, non-ionic dispersants, or a combination thereof. In some embodiments, the dispersant is, or comprises, an anionic dispersant. In other embodiments, the dispersant is, or comprises, a non-ionic dispersant. In any embodiments, the dispersant may be a low-metal content dispersant, such as a low sodium dispersant, low calcium dispersant, low potassium dispersant, or a combination thereof, and may be a low-metal content non-ionic dispersant, such as a low sodium non-ionic dispersant, low calcium non-ionic dispersant, low potassium non-ionic dispersant, or a combination thereof.

In any embodiments, the dispersant may be selected from one or more of:
homo-polymeric dispersants, such as, but not limited to, polyacrylic acid, polyvinyl alcohol, polyvinyl pyrrolidone, polystyrene sulfonate, polyvinyl sulfonate, polyethyleneimine or a combination thereof;
random or statistical copolymers, such as, but not limited to, polyethylene glycol/polyisobutylene succinic acid, vinylpyrrolidone/vinylcaprolactam, or a combination thereof;
block copolymers, such as, but not limited to, polyethyleneoxide/polypopyleneoxide, fatty acid/polyethyleneoxide, polyethoxylated alcohols, polyethoxylated diamines, or a combination thereof;
naphthalene sulfonate formaldehyde condensate;
lignosulfonate;
ethoxylated lignosulfonate;
or any combination thereof.

C. Freezing Point Depressant Compound The freezing point depressant compound is a compound that reduces the freezing point of the formulation relative to a freezing point of a similar formulation that does not include the freezing point depressant compound. Depressing the freezing point may improve the utility of the formulation by allowing use at lower temperatures and/or by improving the physical stability of the of the formulation when subjected to temperature shifts or freeze-thaw cycles. In certain embodiments, the freezing point depressant supports maintenance of viscosity by providing improved stability under freeze-thaw conditions. In some embodiments, the freezing point depressant is a glycol, sugar, water soluble salt, or a combination thereof. The glycol may be ethylene glycol, propylene glycol, glycerol, dipropylene glycol, tri-propylene glycol, or a combination thereof. In certain embodiments, the freezing point depressant is, or comprises, propylene glycol.

The sugar may be a water soluble sugar or polysaccharide. In some embodiments, the sugar has a molecular weight 1,000 Daltons or lower, such as from 180 Daltons to 1,000 Daltons. The sugar may be selected from ribose, xylose, glucose, fructose, mannose, sucrose, maltose, isomaltose, trehalose, xylitol, mannitol, sorbitol, dextrose, galactose, lactose, maltodextrin, saccharose, or a combination thereof.

The water soluble salt may be any water soluble salt suitable for use in agricultural formulations, typically a non-toxic water soluble salt. In some embodiments, the water soluble salt is a halide, nitrate, sulfate or phosphate salt. In some embodiments, the water soluble salt is a lithium, sodium, potassium, magnesium, calcium, ammonium or aluminum salt. And in certain embodiments, the water soluble salt may be selected from fluoride, chloride, iodide, nitrate, sulfate or phosphate salts of lithium, sodium, potassium, magnesium, calcium, ammonium or aluminum.

In any embodiments, the freezing point depressant, and an amount thereof, is selected to reduce the freezing point of the aqueous suspension formulation to below the freezing point of water, that is, to below 0° C. In some embodiments, the amount of the freezing point depressant is sufficient to provide a freezing point of the aqueous suspension formulation of below −1° C., such as below −2° C., below −3° C., below −4° C. or below −5° C., as measured by rheology and known to a person of ordinary skill in the art, such as by using a rheometer. In some embodiments, the freezing point of the formulation is from 0° C. to −1° C., from 0° C. to −2° C., from −1° C. to −3° C., from −2° C. to −4° C., from −3° C. to −5° C., from −4° C. to −6° C., from −5° C. to −7° C., from −5° C. to −8° C., from −5° C. to −9° C., or from −5° C. to −10° C.

In some embodiments, the aqueous suspension formulation comprises from greater than zero to 25 wt % or more of the freezing point depressant compound, such as from 1 wt % to 25 wt %, or from 5 wt % to 20 wt % of the freezing point depressant compound.

D. Buffer and/or Partially Neutralized Base

The buffer and/or partially neutralized base is selected to provide a desired pH of the aqueous suspension formulation. In some embodiments, the pH is from 6 or below to 11 or more, such as from 7 to 11, from 7 to 10.5, from 6 to 10, from 6 to 9, or from 6 to 8.

The buffer and/or partially neutralized base is any buffer and/or base that is suitable for use in an agricultural application. In some embodiments, the buffer is a phosphate, phthalate, CHES, phosphonate, sulfonate, or borate buffer, or a combination thereof. In some embodiments, the buffer is a phosphate buffer, and in other embodiments, the buffer is a borate buffer. In one embodiment, the buffer comprises phthalate.

In other embodiments, the buffer and/or partially neutralized base comprises an amino alcohol, such as ethanolamine, diethanolamine, triethanolamine, or a combination thereof. However, in alternative embodiments, the buffer and/or partially neutralized base does not include an amino alcohol.

E. Optional Additional Components

In some embodiments, the formulation may further comprise one or more additional components, such as a viscosity modifier, biocide, antifoam, low molecular weight surfactant, agriculturally active compound, or a combination thereof.

In some embodiments, the formulation does not comprise more than 0.1 wt % of a compound comprising a primary amine, secondary amine, and/or tertiary amine, such as from zero to 0.1 wt % of such a compound, or zero wt % of such a compound.

In some embodiments, the formulation does not comprise more than 0.1 wt % of a quaternary ammonium compound, such as from zero to 0.1 wt %, or zero wt % of such a compound.

In some embodiments, the formulation does not comprise more than 0.1 wt % in total of any metal, metal ion, or combination thereof, such as from zero to 0.1 wt %, from zero to 0.05 wt %, from zero to 0.02 wt %, from zero to 0.005 wt %, or from zero to 0.002 wt % total metal and/or metal ion. In some embodiments, the formulation does not comprise more than 0.002 wt % in total, such as from zero to 0.002 wt %, of any metal, metal ion, or combination thereof, selected from Group 1 or Group 2 of the periodic table.

i. Viscosity Modifier

In some embodiments, the formulation comprises a viscosity modifier. In some embodiments, the viscosity modifier is selected from a polysaccharide or a clay, or a combination thereof. The polysaccharide may be xanthan, gellan, agar, guar, cellulose, or a chemically modified form of a polysaccharide, or a combination thereof. The clay may be kaolin, attapulgite, bentonite, laponite, or a combination thereof. In some embodiments, the viscosity modifier is, or comprises, xanthan. And in some embodiments, the viscosity modifier is a combination of xanthan and a clay, such as xanthan and attapulgite and/or kaolin.

The viscosity modifier may be present in an amount of from 0.01 wt % to 15 wt %. In certain embodiments, the viscosity modifier is a polysaccharide or a chemically modified polysaccharide, such as xanthan, gellan, agar, guar or cellulose, or a combination thereof, in an amount of from 0.01 wt % to 0.5 wt %. In certain embodiments, the viscosity modifier is a clay, such as kaolin, attapulgite, bentonite, laponite, or a combination thereof, and is present in an amount of from 0.1 wt % to 15 wt %.

ii. Biocide

In some embodiments, the formulation comprises one or more biocides. The biocide may be selected to reduce or prevent spoilage of the formulation or one or more components thereof. In some embodiments, the biocide is selected to reduce or prevent spoilage of a viscosity modifier and/or a freezing point depressant, such as a sugar and/or a glycol. In some embodiments, the biocide is selected from benzisothiazolin-3-one, benzoic acid, 2-(2H-benzotriazol-2-yl)-6-dodecyl-4-methyl-phenol, 2-bromo-2-nitro-1,3-propanediol, butylated hydroxyanisole, butylated hydroxytoluene, potassium benzoate, propyl gallate, propylhydroxy benzoate, sodium nitrite, or a combination thereof. In certain embodiments, the biocide is present in an amount of from 0.01 wt % to 0.1 wt %.

iii. Surfactant

In some embodiments, the formulation comprises a surfactant that is different from the dispersant. The surfactant may be a low molecular weight surfactant. The surfactant may have a molecular weight of from 150 Daltons to less than 1,200 Daltons. And/or the surfactant may be present in the formulation in an amount of from 0.1 wt % to 10 wt %.

The surfactant may be an anionic surfactant, a cationic surfactant, a nonionic surfactant, a quaternary ammonium surfactant, a zwitterionic surfactant, or a combination thereof. In some embodiments, the surfactant is an anionic surfactant, a cationic surfactant, a nonionic surfactant, or a combination thereof.

In any embodiments, the anionic surfactant is a citrate, carbonate, phosphate, phosphonate, sulfate, or sulfonate. The anionic surfactant may be an ester of an alcohol, alcohol alkoxylate (for example, an alcohol ethoxylate and/or alcohol propoxylate), tristyryl phenol ethoxylate, fatty acid, natural oil, or a combination thereof. In certain embodiments, the anionic surfactant is a citrate, carbonate, phosphate, phosphonate, sulfate, or sulfonate ester of an alcohol, alcohol alkoxylate, tristyryl phenol ethoxylate, fatty acid, or natural oil, or any combination thereof.

The cationic surfactant may be an ethoxylated amine, such as an ethoxylated amine of a natural oil, alcohol, fatty acid, or a combination thereof.

The nonionic surfactant may be an alkoxylate of an alcohol, natural oil, or a combination thereof, such as an ethoxylate and/or propoxylate of an alcohol, natural oil, or a combination thereof.

The quaternary ammonium surfactant may comprise at least one chain having at least 6 carbon atoms attached to the quaternary ammonium head group, such as from 6 to 20 carbon atoms, or from 6 to 12 carbon atoms.

And in some embodiments, the zwitterionic surfactant comprises a positively charged group, such as a quaternary ammonium group, and a negatively charged group, such as a carboxylic acid moiety, sulfonic acid moiety, or a phosphoric acid moiety. An example of a zwitterionic surfactant is cocamidopropyl betaine.

In certain embodiments, the surfactant is an anionic surfactant, and may be selected from a phosphate, phosphonate, sulfate, or sulfonate ester of an alcohol, alcohol ethoxylate, tristyryl phenol ethoxylate, fatty acid, or natural oil, or any combination thereof.

In other embodiments, the surfactant is a nonionic surfactant, and may be selected from an alkoxylate of an alcohol, natural oil, or a combination thereof.

Particularly with respect to surfactants, a person of ordinary skill in the art understands that an alkoxylate group (for example, ethoxylate or propoxylate) may include one or more than one alkoxy moiety (i.e., may be polyalkoxylated), such as from 1 to 200 or more alkoxy moieties. And in some embodiments, an alkoxylate group includes from more than one to 200 alkoxy groups, such as from 4 to 200, or from 4 to 150 alkoxy groups.

iv. Antifoam

In some embodiments, the formulation comprises one or more antifoams. The antifoam may be selected to reduce or prevent foaming during manufacture, handling, and/or use of the formulation. In some embodiments, the antifoam is an emulsion of a silicone oil. In some embodiments, the antifoam is present in an amount of from 0.01 wt % to 1.0 wt %.

F. Agriculturally Active Compound The disclosed formulation may further comprise an agriculturally active compound. Additionally, or alternatively, the formulation may be used in combination with one or more agriculturally active compounds, typically as part of an agricultural composition for application to a crop, seeds that may be sown to produce a crop, harvested produce, and/or soil into which a crop has been or may be planted or sown. The agricultural composition may be a diluted composition, formed, at least in part, by diluting the disclosed formulation with a suitable solvent or mixture of solvents, for example, water.

Embodiments of the disclosed formulation are useful for enhancing the effect of a variety of agrochemicals, including fungicides, antiviral agents, bactericides, herbicides, insecticidal/acaricidal agents, molluscicides, nematicides, soil pesticides, plant control agents, synergistic agents, fertilizers and soil conditioners.

In one embodiment, the presently disclosed formulation is useful for enhancing the fungicidal effect of a variety of fungicides. Fungicides for use with the disclosed formulation are well known to those of skill in the art and include, without limitation those set forth by class in Table 1:

TABLE 1

| Family & Group # | Common Names | Trade Names (Combination Products) |
|---|---|---|
| Benzimidazole (Group 1) | benomyl | Benlate, Tersan 1991 |
| | thiabendazole | Arbotect 20-S, Decco Salt No. 19, LSP |
| | | Flowable Fungicide, Mertect 340-F |
| | thiophanate-methyl | Cavalier, Cleary's 3336, OHP 6672, Regal |
| | | SysTec, Tee-Off, |
| | | T-Methyl 4.5F AG, TM 85, Topsin M |
| Dicarboximide (Group 2) | iprodione | Epic 30, Ipro, Meteor, Nevado, OHP Chipco |
| | | 26019, Rovral, (Interface) |
| | vinclozolin | Curalan, Ronilan |
| Phenylpyrroles (Group 12) | fludioxonil | Cannonball, Emblem, Maxim, Medallion, |
| | | Mozart, Scholar, Spirato, (Academy, Miravis |
| | | Prime, Palladium, Switch) |
| Anilinopyrimidines (Group | cyprodinil | Vangard (Palladium, Switch, Inspire Super) |
| 9) | pyrimethanil | Penbotec, Scala, (Luna Tranquility) |
| Hydroxyanilide (Group 17) | fenhexamid | Decree, Elevate, Judge |
| | fenpyrazamine | Protexio |
| Carboxamide (Group 7) | boscalid | Emerald, Endura, (Encartis, Honor, Pageant, |
| | | Pristine) |
| | carboxin | Vitavax |
| | fluopyram | Luna Privilege, Velum Prime (Broadform, |
| | | Luna Experience, Luna Sensation, Luna |
| | | Tranquility, Propulse) |
| | flutolanil | Contrast, Moncut, ProStar |
| | fluxapyroxad | (Lexicon, Merivon, Orkestra) |
| | inpyrfluxam | Excalia |
| | isofetamid | Kenja |
| | oxycarboxin | Carboject, Plantvax |
| | penthiopyrad | Fontelis, Velista, Vertisan |
| | pydiflumetofen | Miravis, Posterity, Miravis Ace A (Miravis |
| | | Neo, Miravis Prime, Miravis Duo, Miravis |
| | | Top) |
| | solatenol | Aprovia (Contend A, Elatus, Mural) |
| | (benzovindiflupyr) | |
| Phenylamide (Group 4) | mefenoxam | Apron, Ridomil Gold, Subdue MAXX, |
| | | (Quadris Ridomil Gold, Uniform) |
| | metalaxyl | Acquire, Allegiance, MetaStar, Ridomil, |
| | | Sebring, Subdue |
| | oxadixyl | Anchor |
| Phosphonate (Group P7) | aluminum tris | Aliette, Flanker, Legion, Signature, Areca |
| | Phosphorous Acid | Agri-Fos, Alude, Appear, Fiata, Fosphite, |
| | | Phospho Jet, Phostrol, Rampart, Reload |
| Cinnamic acid (Group 40) | dimethomorph | Forum, Stature, (Orvego, Zampro) |
| | mandipropamid | Micora, Revus, (Revus Top) |
| OSBPI (Group 49) | oxathiapiprolin | Segovis |
| Triazoles carboxamide | ethaboxam | V-10208 |
| (Group 22) | | |
| Group 27 | cymoxanil | Curzate, (Tanos) |
| Carbamate (Group 28) | propamocarb | Banol, Previcur, Proplant, Tattoo |
| Benzamide (Group 43) | fluopicolide | Adorn, Presidio |

Demethylation-inhibiting (Group 3)

| | | |
|---|---|---|
| Piperazines | triforine | Funginex, Triforine |
| Pyrimidines | fenarimol | Focus, Rubigan, Vintage |
| Imidazole | imazalil | Fungaflor, (Raxil MD Extra) |
| | triflumizole | Procure, Terraguard, Trionic |
| Triazoles | cyproconizole | Sentinel |
| | difenoconazole | Dividend, Inspire, (Academy, Briskway, |
| | | Contend A, Inspire Super, Quadris Top, Revus |
| | | Top) Miravis Duo |
| | fenbuconazole | Enable, Indar |
| | flutriafol | Topguard, (Topguard EQ) |
| | mefentrifluconazole | Maxtima (Navicon) |
| | metconazole | Quash, Tourney |
| | ipconazole | Rancona |
| | myclobutanil | Eagle, Hoist, Immunox, Laredo, Nova, Rally, |
| | | Sonoma, Systhane |
| | propiconazole | Alamo, Banner, Break, Bumper, Infuse, |
| | | Kestrel Mex, Miravis Ace B, PropiMax, |
| | | ProPensity, Strider, Tilt, Topaz, (Aframe Plus, |
| | | Concert, Contend B, Headway, Quilt Xcel, |
| | | Stratego) |
| | prothioconazole | Proline (Propulse) |
| | tebuconazole | Bayer Advanced, Elite, Folicur, Lynx, Mirage, |
| | | Orius, Raxil, Sativa, Tebucon, |
| | | Tebuject, Tebusha, Tebustar, Toledo, |
| | | (Absolute, Luna Experience, |
| | | Unicorn), etc. |
| | tetraconazole | Mettle |
| | triadimefon | Bayleton, Strike, (Armada, Tartan, TrÍigo) |
| | triadimenol | Baytan |
| | triticonazole | Charter, Trinity, (Pillar) |
| Morpholine (Group 5) | piperalin | Pipron |
| | spiroxamine | Accrue |
| Group U6 | cyflufenamid | Torino |
| Group 50 | metrafenone | Vivando |
| | pyriofenone | Prolivo |
| QoI Strobilurins (Group 11) | azoxystrobin | Abound, Aframe, Dynasty, Heritage, Protété, |
| | | Quadris, Quilt, (Aframe Plus, |
| | | Briskway, Contend B, Dexter Max, Elatus, |
| | | Headway, Mural, Quadris Top, |
| | | Quilt Xcel, Renown, Topguard EQ, Uniform) |
| | femoxadone | (Tanos) |
| | fenamidone | Fenstop, Reason |
| | fluoxastrobin | Aftershock, Disarm, Evito, Fame |
| | kresoxim-methyl | Cygnus, Sovran |
| | mandestrobin | Intuity, Pinpoint |
| | picoxystrobin | Aproach |
| | pyraclostrobin | Cabrio, Empress, Headline, Insignia, Stamina, |
| | | (Honor, Lexicon, Merivon, |
| | | Navicon, Orkestra, Pageant, Pillar, Pristine) |
| | trifloxystrobin | Compass, Flint, Gem, (Absolute, Armada, |
| | | Broadform, Interface, Luna Sensation, |
| | | Stratego, Tartan, Trigo) |
| Quinoline (Group 13) | quinoxyfen | Quintec |

Inorganic Compounds

| | | |
|---|---|---|
| Coppers (Group M1) | bordeaux | None |
| | copper ammonium | Copper Count-N |
| | complex | |
| | copper hydroxide | Champ, Champion, Kalmor, Kentan, Kocide, |
| | | Nu-Cop |
| | copper oxide | Nordox |
| | copper oxychloride | C—O—C—S, Oxycop |
| | copper sulfate | Cuprofix Disperss, many others |
| Sulfur (Group M2) | sulfur | Cosavet, Kumulus, Microthiol |
| | | Disperss, Thiosperse |
| Lime sulfur | Ca polysulfides | Lime Sulfur, Sulforix |
| Ethylenebisdithiocarbamates | mancozeb | Dithane, Fore, Penncozeb, Protect, Manex, |
| (EBDC) (Group M3) | | Manzate, Roper, Wingman, (Dexter Max, |
| | | Gavel) |
| | maneb | Maneb |
| | metiram | Polyram |
| EBDC-like (Group M3) | ferbam | Carbamate, Ferbam |
| | thiram | Difiant, Spotrete, Thiram |
| | ziram | Ziram |
| Aromatic Hydrocarbon | dicloran (DCNA) | Allisan, Botran |
| (Group 14) | etridizole | Terrazole, Truban |
| | pentachloronitrobenzene | Autilus, Defend, Engage, PCNB, Terraclor, |
| | | (Premion) |
| Chloronitrile (Group M5) | chlorothalonil | Bravo, Daconil, Docket, Echo, Ensign, |
| | | Exotherm Termil, Funginil, Legend, |
| | | Manicure, Pegasus, Terranil, (Concert, |
| | | Spectro) |
| Phthalimides (Group M4) | captan | Captan |
| Guanidines (Group U12) | dodine | Syllit |
| QiI fungicides (Group 21) | cyazofamid | Ranman, Segway |
| Polyoxin (Group 19) | polyoxin | Affirm, Endorse, Oso, Ph-D, Tavano, Veranda |
| Group 29 | fluazinam | Omega, Secure |
| Thiazolidine (U13) | flutianil | Gatten |

Fungicides are cataloged more broadly by the Fungicide Resistance Action Committee (FRAC) in the FRAC Code List 2022 and reproduced in Appendix 1 and which is incorporated herein by reference in its entirety.

In one embodiment, the disclosed formulation is used in combination with one or more compounds from the Families or Groups set forth in Table 1, Appendix 1, or both. In certain embodiments, the formulation is used in combination with one or more fungicides recited in column 1 of Table 1.

In particular embodiments, the disclosed formulation is used in combination with one or more of a fungicide selected from the benzimidazoles, dicarboximides, phenylpyrroles, anilinopyrimidines, hydroxyanilides, carboxamides, phenyl amides, phosphonates, cinnamic acids, oxysterol binding protein inhibitors (OSBPI), triazole carboxamides, cymoxanil, carbamates, benzamides, demethylation inhibiting piperazines, demethylation inhibiting pyrimidines, demethylation inhibiting azoles, including imidazoles, and triazoles, such as cyproconazole, difenoconazole, fenbuconazole, flutriafol, mefentrifluconazole, metconazole, ipconazole, prothioconazole, tebuconazole, tetraconazole, triadimefon, triadimenol, triticonazole, morpholines, cyflufenamid, metrafenone, pyriofenone, strobilurins, copper ammonium complex, copper hydroxide, copper oxide, copper oxychloride, copper sulfate, sulfur, lime sulfur, ethylenebisdithiocarbamates, aromatic hydrocarbons, phthalimides, guanidines, polyoxins, fluazinam and thiazolidines.

Particular fungicides that are potentiated by use in combination with the disclosed formulation according to the methods herein by administration of an apyrase inhibitor are coppers, such as copper octanoate, copper hydroxide, copper sulfate and the like, myclobutanil, propiconazole, tebuconazole, epoxiconazole, difenoconazole, triticonazole, and prothioconazole.

In one embodiment, the combined treatment with a selected fungicide and the disclosed formulation provides synergistic fungicidal activity against plant pathogenic fungi.

In one embodiment, the disclosure provides compositions and methods of treating plants or plant seeds infected with or at risk of being infected with a fungal pathogen. In one embodiment compositions of the present disclosure comprise a formulation of a fungicide, the disclosed formulation, and a phytologically acceptable carrier. In another embodiment, the fungicide and formulation are administered in separate compositions. In further embodiments, an agricultural or horticultural fungicide is used in combination with other compounds in addition to the disclosed formulation. Such other compounds can be administered in the same or separate compositions as the fungicide and/or formulation. Examples of the other components include known carriers to be used to conduct formulation. Additional examples thereof include conventionally-known herbicides, insecticidal/acaricidal agents, nematodes, soil pesticides, plant control agents, synergistic agents, fertilizers, soil conditioners, and animal feeds. In one embodiment, the inclusion of such other components yields synergistic effects on crop growth.

In one embodiment, the disclosed formulations are used to potentiate the effect of a herbicide. Exemplary herbicides for use in combination with the formulation are known to those of skill in the art and include, without limitation, those described in Appendix 2. By way of example, suitable herbicides for use in combination with the disclosed formulation include inhibitors of acetyl CoA synthase, inhibitors of acetolactate synthesis, inhibitors of microtubule assembly, inhibitors of microtubule organization, auxin mimics, photosynthesis inhibitors, deoxy-D-xylulose phosphate synthase inhibitors, enolpyruvyl shikimate phosphate synthase inhibitors, phytoene desaturase inhibitors, glutamine synthetase inhibitors, dihydropteroate synthesis inhibitors, protoporphyrinogen oxidase inhibitors, cellulose synthesis inhibitors, uncouplers, hydroxyphenyl pyruvate dioxygenase inhibitors, fatty acid thioesterase inhibitors, serine-threonine protein phosphatase inhibitors, solanesyl diphosphate synthase inhibitors, inhibitors of very long-chain fatty acid synthesis, homogentisate solanesyltransferase inhibitors, lycopene cyclase inhibitors,

In one embodiment, the disclosed formulation is used to potentiate the effect of an insecticide. Exemplary insecticides for use in combination with the disclosed formulation are known to those of skill in the art and include, without limitation, those described in Appendix 3.

### III. Method for Using the Formulation

Embodiments of a method for using the disclosed formulation comprise diluting the formulation in a suitable diluent, such as water, to form an agricultural composition suitable for application to a plant, part of a plant, a seed, soil where a plant is or will be growing, or soil where a seed has been or will be sown. The method may further comprise applying the agricultural composition to a plant, part of a plant, a seed, soil where a plant is or will be growing, or soil where a seed has been or will be sown.

In some embodiments, the disclosed formulation comprises one or more agriculturally active compounds and the agricultural composition is formed by diluting the formulation with a suitable solvent, such as water, to a concentration suitable for agricultural application. Optionally, one or more additional agriculturally active compounds may be added before, during and/or after dilution of the formulation.

In other embodiments, the formulation does not comprise an agriculturally active compound, and the agricultural composition is formed by diluting the formulation in a suitable solvent, such as water, with a concentration suitable for agricultural use. In such embodiments, forming the agricultural composition may further comprise adding one or more agriculturally active compounds, either to water before the formulation is added, concurrently while the formulation is diluted with water, and/or subsequently to a diluted mixture comprising the formulation.

In certain non-limiting embodiments, the disclosed formulation is diluted for agricultural application in an amount sufficient to provide the first active compound at: from about 0.01 to about 80% weight to weight in a final composition, or from about 25% to about 55%, such as from about 30% to about 50%, from about 35% to about 45%, such as about 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 20, 30, 40, 50, 55, 60 or 80% weight to weight in a final composition. In one embodiment the first active compound is provided at from about 0.01 to about 50%, such as from about 15% to about 50%, from about 20% to about 45%, from about 25% to about 40%, such as about 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 15, 20, 30, 40 or 50% volume to volume in a final diluted composition.

In some embodiments, the agriculturally active compound(s) is present in the agricultural composition at a concentration that is less than a concentration of the agriculturally active compound(s) that is recommended for use in the absence of the formulation disclosed herein, such as in the absence of (E)-3-methyl-N′-(1-(naphthalen-2-yl)ethylidene)benzohydrazide.

In some embodiments, a method of making the agricultural composition comprises adding the formulation disclosed herein to water in an amount sufficient to potentiate the agriculturally active compound(s), and adding the agriculturally active compound(s) in amounts sufficient to provide a concentration in the agricultural composition that is less than a concentration that is recommended for use in the absence of the disclosed formulation, such as in the absence of (E)-3-methyl-N′-(1-(naphthalen-2-yl)ethylidene)benzohydrazide. A person of ordinary skill in the art understands that the disclosed formulation and the agriculturally active compounds may be added to water sequentially in any order, or substantially simultaneously, to form the agricultural composition.

In any embodiments, the one or more agriculturally active compounds may be an agricultural or horticultural pesticide, such as an acaricide, antimicrobial, fungicide, herbicide, insecticide, molluscicide, or nematocide, or a combination thereof, as disclosed herein. In some embodiments, the method is a method for controlling or preventing fungal growth.

Crops that can be treated, include those plagued by various pathogens, including without limitation, bacteria, viruses, fungal pathogens, mites, nematodes, molluscs, weeds or other pests, as is known to those of ordinary skill in the agricultural arts. By way of example, such agricultural and horticultural crops that can be treated according to the present disclosure include plants, whether genetically modified or not, including their harvested products, such as: cereals; vegetables; root crops; potatoes; trees such as fruit trees, for example banana trees, tea, coffee trees, or cocoa trees; grasses; lawn grass; or cotton.

Agricultural compositions comprising the disclosed formulation may be applied to each part of plants, such as leaves, stems, patterns, flowers, buds, fruits, seeds, sprouts, roots, tubers, tuberous roots, shoots, or cuttings. The formulation may also be applied to improved varieties, cultivars, as well as mutants, hybrids and genetically modified embodiments of these plants.

Agricultural compositions comprising the disclosed formulation may be used to conduct seed treatment, foliage application, soil application, or water application, so as to control various diseases occurring in agricultural or horticultural crops, including flowers, lawns, and pastures.

Agricultural compositions comprising the disclosed formulation are useful for potentiating the effects of antimicrobial agents. For example, the disclosed formulation can be used in combination with an antimicrobial agent to combat bacterial and viral infection.

Embodiments of the disclosed formulation are useful for potentiating the effects of herbicides. For example, the disclosed formulation can be used in combination with one or more herbicides to control weeds or other unwanted vegetation.

Embodiments of the disclosed formulation are useful for potentiating the effects of insecticides. For example, the disclosed formulation can be used in combination with one or more insecticides to control insect infestation.

Embodiments of the disclosed formulation are useful for potentiating the effects of acaricides or miticides. For example, the disclosed formulation can be used in combination with one or more acaricidal agents to control mites.

Embodiments of the disclosed formulation are useful for potentiating the effects of molluscicides. For example, the disclosed formulation can be used in combination with one or more molluscicides to prevent interference of slugs or snails with a crop.

Embodiments of the disclosed formulation are useful for potentiating the effects of nematocides. For example, the disclosed formulation can be used in combination with one or more nematocides to prevent interference of nematodes with a crop.

Embodiments of the disclosed formulation are particularly useful for potentiating the effects of fungicides against plant fungal pathogens. Examples of pathogens treated according to the present disclosure include, without limitation, Botrytis cinerea, Colletotrichum graminicola, Fusarium oxysporum, Sclerotiana sclerotiorum, Verticillium dahlia, Mycosphaerella graminicola and Sphacelotheca reiliana.

Botrytis cinerea is an airborne plant pathogen with a necrotrophic lifestyle attacking over 200 crop hosts worldwide. It mainly attacks dicotyledonous plant species, including important protein, oil, fiber and horticultural crops, grapes and strawberries and also Botrytis also causes secondary soft rot of fruits and vegetables during storage, transit and at the market. Many classes of fungicides have failed to control Botrytis cinerea due to its genetic plasticity.

The genus Colletotrichum comprises ˜600 species attacking over 3,200 species of monocot and dicot plants. Colletotrichum graminicola primarily infects maize (Zea mays), causing annual losses of approximately 1 billion dollars in the United States alone (Connell et al., 2012).

Fusarium wilt of banana, caused by the soil-borne fungus Fusarium oxysporum fsp. cubense, is a major threat to banana production worldwide. No fungicides are currently available to effectively control the disease once plants are infected (Peng J et al., 2014).

The white mold fungus Sclerotinia sclerotiorum is known to attack more than 400 host species and is considered one of the most prolific plant pathogens. The majority of the affected crop species are dicotyledonous, along with a number of agriculturally significant monocotyledonous plants. Some important crops affected by S. sclerotiorum include legumes (soybean), most vegetables, stone fruits and tobacco.

The ascomycete Verticillium dahliae is a soil-borne fungal plant pathogen that causes vascular wilt diseases in a broad range of dicotyledonous host species. V. dahliae can cause severe yield and quality losses in cotton and other important crops such as vegetables, fibers, fruit, nut trees, forest trees and ornamental plants.

The ascomycete fungus Mycosphaerella graminicola (anamorph: Septoria tritici) is one of the most important foliar diseases of wheat leaves, occurring wherever wheat is grown. Yield losses attributed to this disease range from 25%-50%, and are especially high in Europe, the Mediterranean region and East Africa. Infection by M. graminicola is initiated by air borne ascospores produced on residues of last season's crop. Primary infection usually occurs after seedlings emerge in spring or fall. The mature disease is characterized by necrotic lesions on the leaves and stems of infected plants.

The basidiomycete fungus Sphacelotheca reiliana infects corn (Zea mays) systemically, causing Head Smut. Yield loss attributed to the disease is variable, and is directly dependent on the incidence of the disease. The fungus overwinters as diploid teliospores in crop debris or soil. Floral structures are converted to son containing masses of powdery teliospores that resemble mature galls of common smut.

Examples of crops to be treated and plant diseases (pathogens) to be controlled using the presently disclosed compounds and compositions include, without limitation:

Sugar beet: brown spot disease (Cercospora beticola), black root disease (Aphanomyces cochlioides), root rot disease (Thanatephorus cucumeris), leaf rot disease (Thanatephorus cucumeris), and the like.

Peanut: brown spot disease (Mycosphaerella arachidis), leaf mold (Ascochyta sp.), rust disease (Puccinia arachidis), damping-off disease (Pythium debaryanum), rust spot disease (Alternaria alternata), stem rot disease (Sclerotium rolfsii), black rust disease (Mycosphaerella berkeleyi), and the like.

Cucumber: powdery mildew (Sphaerotheca fuliginea), downy mildew (Pseudoperonospora cubensis), gummy stem blight (Mycosphaerella melonis), wilt disease (Fusarium oxysporum), Sclerotinia rot (Sclerotinia sclerotiorum), gray mold (Botrytis cinerea), anthracnose (Colletotrichum orbiculare), scab (Cladosporium cucumerin), brown spot disease (Corynespora cassiicola), damping-off disease (Pythium debaryanum, Rhizoctonia solani Kuhn), Phomopsis root rot disease (Phomopsis sp.), Bacterial spot (Pseudomonas syringae pv. Lechrymans), and the like.

Tomato: gray mold disease (Botrytis cinerea), leaf mold disease (Cladosporium flavum), late blight disease (Phytophthora infestans), Verticillium wilt disease (Verticillium albo-atrum, Verticillium dahliae), powdery mildew disease (Oidium neolycopersici), early blight disease (Alternaria solani), leaf mold disease (Pseudocercospora fuliginea), and the like.

Eggplant: gray mold disease (Botrytis cinerea), black rot disease (Corynespora melongenae), powdery mildew disease (Erysiphe cichoracearum), leaf mold disease (Mycovellosiella nattrassii), Sclerotinia rot disease (Sclerotinia sclerotiorum), Verticillium wilt disease (Verticillium dahlia), Mycosphaerella blight (Phomopsis vexans), and the like.

Strawberry: gray mold disease (Botrytis cinerea), powdery mildew disease (Sphaerotheca humuli), anthracnose disease (Colletotrichum acutatum, Colletotrichum fragariae), phytophthora rot disease (Phytophthora cactorum), soft rot disease (Rhizopus stolonifer), fusarium wilt disease (Fusarium oxysporum), Verticillium wilt disease (Verticillium dahlia), and the like.

Onion: neck rot disease (Botrytis allii), gray mold disease (Botrytis cinerea), leaf blight disease (Botrytis squamosa), downy mildew disease (Peronospora destructor), Phytophthora porn disease (Phytophthora porn), and the like.

Cabbage: clubroot disease (Plasmodiophora brassicae), soft rot disease (Erwinia carotovora), black rot disease (Xanthomonas campestris pv. campestris), bacterial black spot disease (Pseudomonas syringae pv. Maculicola, P.s. pv. alisalensis), downy mildew disease (Peronospora parasitica), Sclerotinia rot disease (Sclerotinia sclerotiorum), black spot disease (Alternaria brassicicola), gray mold disease (Botrytis cinerea), and the like.

Common bean: Sclerotinia rot disease (Sclerotinia sclerotiorum), gray mold disease (Botrytis cinerea), anthracnose (Colletotrichum lindemuthianum), angular spot disease (Phaeoisariopsis griseola), and the like.

Apple: powdery mildew disease (Podosphaera leucotricha), scab disease (Venturia inaequalis), Monilinia disease (Monilinia mall), black spot disease (Mycosphaerella pomi), Valla canker disease (Valsa mall), altemaria blotch disease (Alternaria mall), rust disease (Gymnosporangium yamadae), ring rot disease (Botryosphaeria berengeriana), anthracnose disease (Glomerella cingulata, Colletotrichum acutatum), leaf rot disease (Diplocarpon mali), fly speck disease (Zygophiala jamaicensis), Sooty blotch (Gloeodes pomigena), violet root rot disease (Helicobasidium mompa), gray mold disease (Botrytis cinerea), and the like.

Japanese apricot: scab disease (Cladosporium carpophilum), gray mold disease (Botrytis cinerea), brown rot disease (Monilinia mumecola), and the like.

Persimmon powdery mildew disease (Phyllactinia kakicola), anthracnose disease (Gloeosporium kaki), angular leaf spot (Cercospora kaki), and the like.

Peach: brown rot disease (Monilinia fructicola), scab disease (Cladosporium carpophilum), Phomopsis rot disease (Phomopsis sp.), bacterial shot hole disease (Xanthomonas campestris pv. pruni), and the like.

Almond: brown rot disease (Monilinia taxa), spot blotch disease (Stigmina carpophila), scab disease (Cladosporium carpophilum), red leaf spot disease (Polystigma rubrum), altemaria blotch disease (Alternaria alternata), anthracnose (Colletotrichum gloeospoides), and the like.

Yellow peach: brown rot disease (Monilinia fructicola), anthracnose disease (Colletotrichum acutatum), black spot disease (Alternaria sp.), Monilinia kusanoi disease (Monilinia kusanoi), and the like.

Grape: gray mold disease (Botrytis cinerea), powdery mildew disease (Uncinula necator), ripe rot disease (Glomerella cingulata, Colletotrichum acutatum), downy mildew disease (Plasmopara viticola), anthracnose disease (Elsinoe ampelina), brown spot disease (Pseudocercospora vitis), black rot disease (Guignardia bidwellii), white rot disease (Coniella castaneicola), rust disease (Phakopsora ampelopsidis), and the like.

Pear: scab disease (Venturia nashicola), rust disease (Gymnosporangium asiaticum), black spot disease (Alternaria kikuchiana), ring rot disease (Botryosphaeria berengeriana), powdery mildew disease (Phyllactinia mall), Cytospora canker disease (Phomopsis fukushii), brown spot blotch disease (Stemphylium vesicarium), anthracnose disease (Glomerella cingulata), and the like.

Tea: ring spot disease (Pestalotiopsis longiseta, P. theae), anthracnose disease (Colletotrichum theae-sinensis), Net blister blight (Exobasidium reticulatum), and the like.

Citrus fruits: scab disease (Elsinoe fawcettii), blue mold disease (Penicillium italicum), common green mold disease (Penicillium digitatum), gray mold disease (Botrytis cinerea), melanose disease (Diaporthe citri), canker disease (Xanthomonas campestris pv. Citri), powdery mildew disease (Oidium sp.), and the like.

Wheat: powdery mildew (Blumeria graminis f. sp. tritici), red mold disease (Gibberella zeae), red rust disease (Puccinia recondita), brown snow mold disease (Pythium iwayamai), pink snow mold disease (Monographella nivalis), eye spot disease (Pseudocercosporella herpotrichoides), leaf scorch disease (Septoria tritici), glume blotch disease (Leptosphaeria nodorum), Typhula snow blight disease (Typhula incarnata), Sclerotinia snow blight disease (Myriosclerotinia borealis), damping-off disease (Gaeumannomyces graminis), ergot disease (Claviceps purpurea), stinking smut disease (Tilletia caries), loose smut disease (Ustilago nuda), and the like.

Barley: leaf spot disease (Pyrenophora graminea), net blotch disease (Pyrenophora teres), leaf blotch disease (Rhynchosporium secalis), loose smut disease (Ustilago tritici, U. nuda), and the like.

Rice: blast disease (Pyricularia oryzae), sheath blight disease (Rhizoctonia solani), bakanae disease (Gibberella fujikuroi), brown spot disease (Cochliobolus miyabeanus), damping-off disease (Pythium graminicola), bacterial leaf blight (Xanthomonas oryzae), bacterial seedling blight disease (Burkholderia plantarii), brown stripe disease (Acidovorax avenae), bacterial grain rot disease (Burkholderia glumae), Cercospora leaf spot disease (Cercospora oryzae), false smut disease (Ustilaginoidea virens), rice brown spot disease (Alternaria alternata, Curvularia intermedia), kernel discoloration of rice (Alternaria padwickii), pink coloring of rice grains (Epicoccum purpurascens), and the like.

Tobacco: Sclerotinia rot disease (Sclerotinia sclerotiorum), powdery mildew disease (Erysiphe cichoracearum), Phytophthora rot disease (Phytophthora nicotianae), and the like.

Tulip: gray mold disease (Botrytis cinerea), and the like.

Sunflower: downy mildew disease (Plasmopara halstedii), Sclerotinia rot disease (Sclerotinia sclerotiorum), and the like.

Bent grass: Sclerotinia snow blight (Sclerotinia borealis), Large patch (Rhizoctonia solani), Brown patch (Rhizoctonia solani), Dollar spot (Sclerotinia homoeocarpa), blast disease (Pyricularia sp.), Pythium red blight disease (Pythium aphanidermatum), anthracnose disease (Colletotrichum graminicola), and the like.

Orchard grass: powdery mildew disease (Erysiphe graminis), and the like.

Soybean: purple stain disease (Cercospora kikuchii), downy mildew disease (Peronospora manshurica), phytophthora rot disease (Phytophthora sojae), rust disease (Phakopsora pachyrhizi), Sclerotinia rot disease (Sclerotinia sclerotiorum), anthracnose disease (Colletotrichum truncatum), gray mold disease (Botrytis cinerea), Sphaceloma scab (Elsinoe glycines), melanoses (Diaporthe phaseolorum var. sojae), and the like.

Potato: hytophthora rot disease (Phytophthora infestans), early blight disease (Alternaria solani), scurf disease (Thanatephorus cucumeris), Verticillium wilt disease (Verticillium albo-atrum, V. dahlia, V. nigrescens, and the like.

Banana: Panama disease (Fusarium oxysporum), Sigatoka disease (Mycosphaerella fijiensis, M. musicola), and the like.

Rapeseed: Sclerotinia rot disease (Sclerotinia sclerotiorum), root rot disease (Phoma lingam), black leaf spot disease (Alternaria brassicae), and the like.

Coffee: rust disease (Hemileia vastatrix), anthracnose (Colletotrichum coffeanum), leaf spot disease (Cercospora coffeicola), and the like.

Sugarcane: brown rust disease (Puccinia melanocephala), and the like.

Corn: zonate spot disease (Gloeocercospora sorghi), rust disease (Puccinia sorghi), southern rust disease (Puccinia polysora), smut disease (Ustilago maydis), brown spot disease (Cochliobolus heterostrophus), northern leaf blight (Setosphaeria turcica), and the like.

Cotton: seedling blight disease (Pythium sp.), rust disease (Phakopsora gossypii), sour rot disease (Mycosphaerella areola), anthracnose (Glomerella gossypii), and the like.

### IV. Method for Making the Formulation

The disclosed formulation can be made by methods known to persons of ordinary skill in the art. In some embodiments, the method comprises providing the first active compound, the dispersant, the freezing point depressant, the buffer and/or partially neutralized base, and water, and forming the formulation. Optionally, a viscosity modifier, surfactant, biocide, antifoam, and/or agriculturally active compound also may be added. In some embodiments, the solid material in the mixture is mixed with a first portion of water, optionally in the presence of the dispersant, the freezing point depressant, the buffer and/or partially neutralized base, and crushed, such as by stirring with beads, until the solid particles are of a desired size for the formulation. In other embodiments, the solid material, such as the first active compound, may be ground to a suitable size, or provided in such a size, before adding to the water or formulation.

Additional components may be added, including additional water and/or buffer and/or partially neutralized base, to provide a desired pH and concentration. A person of ordinary skill in the art understands that the dispersant, the freezing point depressant, and the buffer and/or partially neutralized base, and also any optional components such as a viscosity modifier, surfactant, biocide, antifoam, and/or agriculturally active compound, may be added in any suitable or convenient order.

In one embodiment, an order of addition of the components is a first portion of water, freezing point depressant, dispersant, small molecule surfactant (if present), antifoam (if present), buffer and/or partially neutralized base, the first active compound, viscosity modifier (if present), biocide (if present), and the balance of water to provide the desired concentration of the formulation. Typically, the mixture is milled after the first active compound is added, for example, to reduce the particle size of the first active compound to a desired size. In some embodiments, the mixture is milled after the first active compound is added and before any additional components are added. In an embodiment, an order of addition of the components may be a first portion of water, followed by freezing point depressant, dispersant, small molecule surfactant (if present), and antifoam (if present), in any order. The pH modifier then is added, such as a buffer and/or partially neutralized base, followed by the first active compound. The mixture then may be milled. Subsequently, a viscosity modifier (if present), and/or biocide (if present), may be added, followed by the balance of water.

In any embodiments, additional buffer, acid, base and/or partially neutralized base may be added to adjust the final pH of the formulation.

### V. EXAMPLES

### Example 1

### Preparation of Stable Aqueous Suspension Concentrate

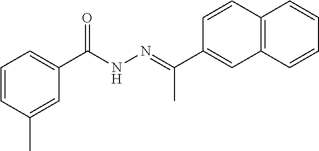 [SMILES: C/C(=N\NC(=O)c1cccc(C)c1)c1ccc2ccccc2c1]

### First Active Compound

2.5 g of the first active compound are placed into a 100 mL glass beaker, together with 0.5 g of dispersant Tamol SN, 1 g of propylene glycol, 0.006 g (10 mM) boric acid powder buffer, 5 g of water, optionally 0.05 g low molecular weight surfactant Surfonic L24-7, and optionally 0.01 g of antifoam SAG 1572.30 g of 2 mm diameter glass beads are added and a mechanical stirrer is used to mill the suspension to below 1.5 microns median diameter, as measured on a Malvern Mastersizer 3000. To the suspension concentrate are added 0.5 g of a pre-gel containing 2% xanthan polysaccharide and 2% biocide Acticide B20, and the mechanical stirrer is run for a further 10 minutes. The pH is adjusted to 9.0 using 2% phosphoric acid or 1M sodium hydroxide as needed. Water is added as needed to bring the final concentration to 25 wt % of compound B. The suspension concentrate is collected by sieving out the glass beads.

### Example 2

### Improved Biological Efficacy

Samples are prepared according to the method described herein, such as in Example 1 above, except that the milling conditions are adjusted to obtain different particle sizes in the various samples. The samples are tested for biological activity in combination with a commercial fungicide. It is expected that the degree of pathogen control will depend upon the particle size.

### Example 3

### Acceptable Chemical Stability

Samples are prepared according to the method described herein, such as in Example 1 above, except that the pH is adjusted such that each sample has a different pH. The samples are assessed for chemical stability by storing them at elevated temperatures and by periodically measuring the remaining concentration of the active ingredient by HPLC. Reference samples are stored at low temperature and also tested at the same time points. It is expected that the results will show that within a particular pH range, chemical stability is acceptable.

### Example 4

### Acceptable Chemical Stability

Samples are prepared according to the method described herein, such as in Example 1 above, except that to particular sub-samples are added low concentrations of certain components including a primary amine, a secondary amine, a tertiary amine, a quaternary amine, or an alkali metal. The chemical stability is assessed as described in Example 3 above. It is expected that the results will show that certain components accelerate chemical degradation and must be excluded from formulations of the present invention.

### Example 5

### Acceptable Physical Stability

Several liters of a formulation are prepared according to the method described herein, such as in Example 1 above, except that some formulation components are replaced with others, such that the components of the composition still fall within the composition ranges described above in section II. Sub-samples are stored at several different temperatures and are periodically assessed for pH, viscosity, appearance, sedimentation and syneresis. It is expected that the formulation will have excellent physical stability.

### Example 6

### Chemical Stability as a Function of pH

A working solution of Compound 1 was prepared in dimethyl sulfoxide at a concentration of 500 μM. 2 μL of the working solution and 198 μL of PBS pH 4.5 or PBS pH 7.4 were added into glass vials to achieve a final concentration of 5 μM. The setup was performed in duplicate. Vials were incubated at 37° C. at 60 rpm in a water bath and taken at designated time points of 0, 2, 4, 6 and 24 hours. For each time point, the incubations were terminated with 1000 μL cold acetonitrile containing internal analytical reference standards. Samples were vortexed for 1 minute then centrifuged at RT at 2500 g for 10 minutes. Aliquots of 200 μL of the supernatant were used for LC-MS/MS analysis.

For the samples incubated in pH 4.5 PBS buffer for times 0, 2, 4, 6, 24 hr the remaining amounts of Compound 1 were respectively 100%, 62.3%, 33.7%, 29.2%, 3.1%. For the samples incubated in pH 7.4 PBS buffer for times 0, 2, 4, 6, 24 hr the remaining amounts of Compound 1 were respectively 100%, 112.4%, 96.2%, 97.8%, 91.1%.

These results show rapid degradation under mildly acidic conditions with an apparent half-life slightly longer than 2 hours at 37° C. The solubility of Compound 1 in water is below the total concentration in this experiment of 5 μM, therefore the actual degradation rate in solution is very rapid with an estimated half-life below one hour. Stability is superior at pH 7.4, relative to acidic conditions.

### Example 7

### Long Term Chemical Stability as a Function of pH

Method: An aqueous suspension concentrate was prepared with the following composition: 30 wt % Compound 1, 2.5 wt % tristyrylphenol ethoxylate surfactant, 2.0 wt % ethyleneoxide-propyleneoxide block co-polymeric dispersant, 5.0 wt % propylene glycol freeze protectant, 0.1 wt % silicone oil antifoam, 52.4% distilled water, and after 2 hours of milling were added 8.0 wt % viscosity modifier gel comprising 2.0% xanthan and 1.0% biocide in water. Aliquots of this suspension were taken and adjusted to pH 6, 7 and 8 with respectively 10 wt % sulfuric acid, pH10 borate buffer and 10 wt % sodium hydroxide. The three samples were sub-divided and stored at room temperature (RT, approximately 25° C.) and 38° C. Control samples were stored at 0° C. for reference. Aliquots were withdrawn periodically and diluted in acetonitrile for analysis by HPLC.

Results: After 1 and 9 months at RT the amounts of Compound 1 remaining in the pH 6 sample were respectively 99% and 86%. After 1 and 9 months at 38° C. the amounts of Compound 1 remaining in the pH 6 sample were respectively 103% and 94%. After 1 and 9 months at RT the amounts of Compound 1 remaining in the pH 7 sample were respectively 103% and 76%. After 1 and 9 months at 38° C. the amounts of Compound 1 remaining in the pH 7 sample were respectively 104% and 89%. After 1 and 9 months at RT the amounts of Compound 1 remaining in the pH 8 sample were respectively 99% and 102%. After 1 and 9 months at 38° C. the amounts of Compound 1 remaining in the pH 6 sample were respectively 99% and 103%.

These results demonstrate that an aqueous suspension of Compound 1 is chemically unstable at neutral or acidic pH, but is stable at pH 8. Additionally, there is a slight trend of faster degradation at RT than at 38° C., which, without being limited to any particular theory, may be the result of a complex relationship between apparent solubility and temperature in this formulation. Due to Compound 1 having much higher solubility in the hydrophobic interior phase of surfactant micelles than in the aqueous phase, and surfactant micelles undergoing phase-changes as a function of temperature, as the temperature rises, the amount of Compound 1 in solution may drop due to micelle instability with rising temperature and the overall rate of degradation decline. Nonetheless, pH is an important factor in the aqueous stability of Compound 1.

### Example 8

### Physical and Chemical Stability as a Function of Buffer

Method: An aqueous suspension was prepared as described in Example 7 and subdivided into 3 aliquots that were adjusted respectively to pH 6, 7 and 8. Each aliquot was divided further into 3 and sets of each material were stored at 0° C., 25° C. and 38° C. After six months storage the pH of all aliquots were measured.

Results: The formulation initially at pH 6 had dropped to pH 3.64, 2.86 and 2.84 respectively when stored at 0° C., 25° C. and 38° C. The formulation initially at pH 7 had dropped to pH 5.06, 4.35 and 3.90 respectively when stored at 0° C., 25° C. and 38° C. The formulation initially at pH 8 had dropped to pH 7.55, 6.95 and 5.80 respectively when stored at 0° C., 25° C. and 38° C.

These results show that in the absence of a buffer to stabilize pH, aqueous suspensions of Compound 1 become more acidic over time as a result of the chemical degradation of Compound 1. Example 7 above shows that the rate of degradation is greater at neutral or low pH, therefore the degradation is autocatalytic in the sense that the more Compound 1 degrades, the lower the pH drops, and the faster the degradation. Buffer is useful to maintain a stable pH (which supports the functioning of viscosity modifiers to prevent sedimentation) and to minimize chemical degradation. As is understood by those of skill in formulations, the amount of buffer will be dependent on the specifics of the amount of Compound 1 and other components present in the formulation and can be determined routinely by one skilled in the art.

### Example 9

### Physical Stability at Low Temperature as a Function of Freeze Protectant

Method: Two aqueous suspensions were prepared substantially as described in Example 7, except that one sample contained the 5 wt % propylene glycol freeze protectant and the other contained none, the balance being made up with water. The samples were subjected to two cycles of freeze-thaw by storing alternately in a freezer below −4° C. and at room temperature. Viscosity was measured using a Brookfield rotating-spindle viscometer.

Results: The two samples remained uniform in appearance without significant sedimentation or syneresis over the short duration of this experiment. The viscosity of the sample without propylene glycol was 480 mPa prior to freeze-thaw challenge and 1100 mPa afterward; and the viscosity of the sample with propylene glycol was 420 mPa both before and after freeze-thaw challenge.

The freeze protectant propylene glycol inhibits the formation of structure (structure here being molecular aggregates of species present in solution in water) in the liquid phase that otherwise creates an unacceptably high viscosity whereby the formulation is unsuitable for pumping and convenient use by the end user.

### Example 10

### Efficacy as a Function of Particle Size

Method: Aqueous suspension concentrates with 30 wt % Compound 1 were prepared as described in example 7, except that the milling conditions were controlled to achieve a range of particle sizes. Specifically, milling was performed using ceramic milling media in a water-jacketed stirred container, and the duration of milling was varied. The samples were diluted in water and bioassayed in the greenhouse at a rate of 20 ppm Compound 1 in pairwise combinations with either of the commercial fungicides Amistar (0.03 L/ha), Imtrex (0.35 L/ha), Proline (0.125 L/ha) or Balaya (0.2 L/ha). Each pairwise combination was used to challenge each of four commercially important pathogenic fungi: Botrytis cinerea (on tomato plants), Zymoseptoria tritici (on wheat plants), Puccinia triticina (on wheat plants) and Phakopsora pachyrhizi (on soybean plants cultivar Siverka). Seeds were sown in 9 cm diameter pots to a depth of 1 to 2 cm using Petersfield potting compost (75% medium grade peat, 12% screened sterilized loam, 3% medium grade vermiculite, 10% grit (5 mm screened, lime free), 1.5 kg PG mix per m\hat{ }3, lime to pH 5.5-6.0 and wetting agent (Vitax Ultrawet 200 ml per m\hat{ }3) and germinated/grown at 23° C. under a 16 hr day/8 hr night light regime. Plants were treated two to three weeks after sowing when they were at the BBCH 11 growth stage (first pair of true leaves (unifoliate) unfolded. A track sprayer was used to treat the plants with the commercial fungicides and Compound 1 using a water volume of 200 L/ha. Plants were inoculated with the appropriate fungi (pathogen) 24 hours after treatment. Four replicates were used for each combination of fungicide, pathogen and formulation. Each plant was evaluated once the disease symptoms were fully expressed between seven to twenty days (depending on the pathogen) for % control of the disease. Appropriate controls were used for all experiments, including an inoculation ‘check’ wherein plants were inoculated with their specific pathogen to assess disease levels. Also, each commercial fungicide was tested on its own as a part of each treatment, this being a ‘control’ benchmark against which the experimental compounds were evaluated. Percentage disease control for each treated plant was calculated to be the average disease severity for the inoculated but untreated plants (‘check’) minus the average disease severity for the treated plants, divided by the ‘check’. Percentage synergy for each combination of formulation plus fungicide (test combination) was calculated to be the disease control for the plants treated only with the fungicide (‘control’) minus the disease control for the test combination, divided by 100% minus the ‘control’. Synergy represents the amount of benefit achieved by adding the Compound 1 formulations to the fungicides, expressed as a percentage of the maximum possible benefit, so that 100% would mean that disease control was complete, and 0% would mean that there was no benefit to the combination.

Results:

The particle sizes of the milled samples were measured using a laser light scattering instrument and the median volume-weighted particle diameters were respectively 1.0, 7.0 and 15 microns with decreasing duration of milling. In the discussion below, for simplicity these samples are designated A1, B7 and C15.

Zymoseptoria tritici: with Amistar there was no consistent synergy, with Imtrex the synergy was 28%, 28%, 4.6% respectively for A1, B7 and C15, with Proline the synergy was 26%, 25%, 61% respectively for A1, B7 and C15, with Balaya the synergy was 51%, 40%, 36% respectively for A1, B7 and C15

Phakopsora pachyrhizi: with Amistar the synergy was 30% for A1 and no synergy for B7 or C15, with Imtrex and Proline there was no significant synergy, with Balaya the synergy was 40%, 33% and 20% respectively for A1, B7 and C15

Puccinia triticina: with Amistar there was no significant synergy, with Imtrex the synergy was 29%, 3% and no synergy respectively for A1, B7 and C15, with Proline or Balaya there was no significant synergy

Botrytis cinerea: with Amistar there was no significant synergy, with Imtrex the synergy was 18%, 6% and no synergy for respectively A1, B7 and C15, with Proline the synergy was 33%, 14% and 10% respectively for A1, B7 and C15, with Balaya there was no significant synergy.

Conclusions: In these greenhouse assays it is apparent that in some cases there was no synergy observed between Compound 1 and the fungicides in controlling some of the pathogens. This could occur because, for instance, the use rate of the commercial fungicide in that particular test was too low or too high, with respect to the extent of plant disease created by the inoculated pathogen, whereby the addition of Compound 1 might be unable to respectively produce any measurable benefit or there would be no opportunity to further improve the disease control above an already high level. In some cases it is also possible that in a particular test the mode of action and detoxification of the fungicide against that pathogen may not involve enzymes modulated by Compound 1, and therefore not be amenable to synergy by an apyrase inhibitor. These results without synergy can be discounted for the purpose of assessing the impact of particle size on efficacy.

In the cases where there is synergy, if we group results by fungicide the following can be highlighted:
a) In combinations with Imtrex, B7 is always better than C15, and A1 is essentially identical to (1 instance) or better than B7 (3 instances), i.e. A1>B7>C15.
b) In combinations with Balaya, B7>C15.
c) In combinations with Amistar, only against Phakopsora pachyrhizi is there synergy and a trend apparent, where again A1>B7>C15.
d) In combinations with Proline, in one instance A1>B7>C15 and in another instance C15>A1=B7.

In the cases where there is synergy, if we instead group results by pathogen the following can be highlighted:
a) Against Zymoseptoria tritici, with Imtrex A1=B7>C15, with Proline C15>A1=B7, with Balaya A1>B7>C15.
b) Against Phakopsora pachyrhizi, with Amistar only A1 has synergy, with Balaya A1>B7>C15.
c) Against Puccinia triticina, with Imtrex A1>B7>C15.
d) Against Botrytis cinerea with both Imtrex and Proline A1>B7>C15

Within this series of experiments there is one apparent contra-example of Proline against Zymoseptoria tritici (based upon a possible outlier value for C15), whereas seven other examples establish the pattern. Overall the suspension concentrate with median particle size 1 micron is more biologically efficacious than the suspension concentrate with median particle size 7 microns, which is more biologically efficacious than the suspension concentrate with median particle size 15 microns. This pattern is valid against all of the pathogens tested here. Of the fungicides tested here the effect is most consistent with Imtrex and Balaya but there are examples with both other fungicides.

### VI. Certain Embodiments

Certain embodiments of the formulations, compositions and methods for their use disclosed herein are described in the following numbered paragraphs:

1. A formulation, comprising an aqueous suspension of a first active compound having a structure

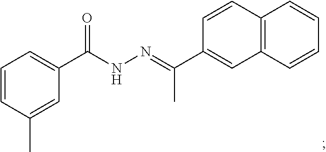 [SMILES: C/C(=N\NC(=O)c1cccc(C)c1)c1ccc2ccccc2c1]

a dispersant;
a freezing point depressant; and
a buffer or partially neutralized base, such that the pH of the formulation is from about 6 to 11;
wherein
particles of the first active compound have a volume-weighted median particle size, as measured by light scattering, of from greater than 0.01 to 20 microns.

2. The formulation of embodiment 1, wherein the formulation comprises from 0.5 wt % to about 60 wt % of the first active compound.

3. The formulation of embodiment 1 or embodiment 2, wherein the formulation comprises from 15 wt % to 40 wt % of the first active compound.

4. The formulation of embodiment 1 or embodiment 2, wherein the formulation comprises less than 15 wt % of the first active compound and the formulation further comprises an inert filler, such that the total amount of suspended material in the formulation is at least 10 wt %.

5. The formulation of any one of embodiments 1-4, wherein the formulation comprises from 0.1 wt % to 15 wt % of the dispersant.

6. The formulation of any one of embodiments 1-5, wherein the formulation comprises from 1 wt % to 10 wt % of the dispersant.

7. The formulation of any one of embodiments 1-6, wherein the dispersant has a molecular weight of from 400 Daltons to 2,000,000 Daltons.

8. The formulation of any one of claims 1-7, wherein the dispersant has a molecular weight of from 1,000 Daltons to 100,000 Daltons.

9. The formulation of any one of embodiments 1-8, wherein the dispersant is an anionic dispersant, a cationic dispersant, a non-ionic dispersant, or a combination thereof.

10. The formulation of embodiment 9, wherein the dispersant is an anionic dispersant.

11. The formulation of embodiment 9, wherein the dispersant is a nonionic dispersant.

12. The formulation of any one of embodiments 1-9, wherein the dispersant is selected from a homo-polymeric dispersant, a random or statistical copolymer, a block copolymer, or a combination thereof.

13. The formulation of any one of embodiments 1-9, wherein the dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypopyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

14. The formulation of any one of embodiments 1-13, wherein the formulation comprises from greater than zero to 25 wt % of the freezing point depressant.

15. The formulation of any one of embodiments 1-14, wherein the formulation comprises from 5 wt % to 20 wt % of the freezing point depressant.

16. The formulation of any one of embodiments 1-15, wherein the freezing point depressant is a glycol, sugar, water soluble salt, or a combination thereof.

17. The formulation of embodiment 16, wherein the sugar has a molecular weight of from 180 Daltons to 1,000 Daltons.

18. The formulation of embodiment 16 or embodiment 17, wherein:
the glycol is ethylene glycol, propylene glycol, glycerol, dipropylene glycol, tri-propylene glycol, or a combination thereof;
the sugar is ribose, xylose, glucose, fructose, mannose, sucrose, maltose, isomaltose, trehalose, xylitol, mannitol, sorbitol, dextrose, galactose, lactose, maltodextrin, saccharose, or a combination thereof;
the water soluble salt is a fluoride, chloride, iodide, nitrate, sulfate or phosphate salt of ammonium, lithium, sodium, potassium, magnesium, calcium or aluminum; or a combination thereof.

19. The formulation of embodiment 18, wherein the freezing point depressant is propylene glycol.

20. The formulation of any one of embodiments 1-19, wherein the freezing point depressant is selected to reduce a freezing point of the formulation to below 0° C.

21. The formulation of any one of embodiments 1-20, wherein the freezing point depressant is selected to reduce a freezing point of the formulation to below −5° C.

22. The formulation of any one of embodiments 1-21, wherein the buffer or partially neutralized base provides a pH of from 7 to 10.5 of the formulation.

23. The formulation of any one of embodiments 1-22, wherein the buffer or partially neutralized base provides a pH of from about 6 to about 8 of the formulation.

24. The formulation of any one of embodiments 1-23, wherein the buffer and/or partially neutralized base is any buffer and/or base that is suitable for use in an agricultural application.

25. The formulation of any one of embodiments 1-24, wherein the buffer is a phosphate, phthalate, CHES, phosphonate, sulfonate, or borate buffer, or a combination thereof.

26. The formulation of embodiment 25, wherein the buffer is a phosphate buffer or a borate buffer.

27. The formulation of any one of embodiments 1-26, wherein the volume-weighted median particle size of the first active compound, as measured by light scattering, is less than about 15 microns.

28. The formulation of embodiment 27, wherein the volume-weighted median particle size of the first active compound, as measured by light scattering, is less than about 7 microns.

29. The formulation of embodiment 27, wherein the volume-weighted median particle size of the first active compound, as measured by light scattering, of from greater than 0.01 to 10 microns.

30. The formulation embodiment 27, wherein the volume-weighted median particle size of the first active compound, as measured by light scattering, of from greater than 0.01 to 5 microns.

31. The formulation of embodiment 27, wherein the volume-weighted median particle size of the first active compound, as measured by light scattering, of from greater than 0.01 to 2 microns.

32. The formulation of embodiment 27, wherein the volume-weighted median particle size of the first active compound, as measured by light scattering, is about 1 micron or less.

33. The formulation of embodiment 27, wherein the volume-weighted median particle size of the first active compound, as measured by light scattering, is about 1 micron.

34. The formulation of embodiment 27, wherein the volume-weighted median particle size of the first active compound, as measured by light scattering, is less than about 1 micron.

35. The formulation of any one of embodiments 1-34, wherein the formulation further comprises a viscosity modifier.

36. The formulation of embodiment 35, wherein the viscosity modifier is selected from a polysaccharide, a chemically-modified polysaccharide, and/or a clay.

37. The formulation of embodiment 36, wherein:
the polysaccharide is xanthan, gellan, agar, guar, cellulose, or a combination thereof;
the clay is kaolin, attapulgite, bentonite, laponite; or
a combination thereof.

38. The formulation of any one of embodiments 35-37, wherein viscosity modifier is present in an amount of from 0.01 wt % to 15 wt %.

39. The formulation of embodiment 38, wherein:
the viscosity modifier is a polysaccharide or a chemically-modified polysaccharide in an amount of from 0.01 wt % to 0.5 wt %; or
the viscosity modifier is a clay and is present in an amount of from 0.1 wt % to 15 wt %.

40. The formulation of any one of embodiments 1-39, wherein the formulation further comprises a biocide.

41. The formulation of embodiment 40, wherein the biocide is selected from benzisothiazolin-3-one, benzoic acid, 2-(2H-benzotriazol-2-yl)-6-dodecyl-4-methyl-phenol, 2-bromo-2-nitro-1,3-propanediol, butylated hydroxyanisole, butylated hydroxytoluene, potassium benzoate, propyl gallate, propylhydroxy benzoate, sodium nitrite, or a combination thereof.

42. The formulation of any one of embodiments 1-41, wherein the formulation further comprises from 0.1 wt % to 10 wt % of a surfactant.

43. The formulation of embodiment 42, wherein the surfactant has a molecular weight of from 150 Daltons to less than 1,200 Daltons.

44. The formulation of embodiment 42 or embodiment 43, wherein the surfactant is an anionic surfactant, a cationic surfactant, a nonionic surfactant, a quaternary ammonium surfactant, a zwitterionic surfactant, or a combination thereof.

45. The formulation of embodiment 44, wherein:
the anionic surfactant is a citrate, carbonate, phosphate, phosphonate, sulfate, or sulfonate ester of an alcohol, alcohol ethoxylate, tristyryl phenol ethoxylate, fatty acid, or natural oil, or any combination thereof;
the cationic surfactant is an ethoxylated amine of a natural oil, alcohol, fatty acid, or a combination thereof; or
the nonionic surfactant is a polyethoxylated and/or polypropoxylate of an alcohol, natural oil, or a combination thereof.

46. The formulation of any one of embodiments 1-45, wherein the formulation further comprises an antifoam.

47. The formulation of embodiment 46, wherein the antifoam is an emulsion of silicone oil.

48. The formulation of embodiment 46 or embodiment 47, wherein the antifoam is present in an amount of from 0.01 wt % to 1 wt %.

49. The formulation of any one of embodiments 1-48, further comprising an agriculturally active compound.

50. The formulation of embodiment 49, wherein the agriculturally active compound is an acaricide, antimicrobial, fungicide, herbicide, insecticide, molluscicide, or nematocide, or a combination thereof.

51. The formulation of embodiment 49, wherein the agriculturally active compound is a fungicide.

52. The formulation of embodiment 51, wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

53. The formulation of embodiment 51, wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridiazole, pentachloronitrobenzene, chlorothalonil, captan, dodine, cyazofamid, polyoxin, fluazinam, flutianil, or a combination thereof.

54. An agricultural composition, comprising water and the formulation of any one of embodiments 1-53.

55. The agricultural composition of embodiment 54, wherein the composition comprises from 0.01 wt % to 10 wt % of the formulation of any one of embodiments 1-54.

56. The agricultural composition of embodiment 54, wherein the formulation is a formulation according to any one of embodiments 1-55 and the agricultural composition further comprises an agriculturally active compound.

57. The agricultural composition of embodiment 56, wherein the formulation of any one of embodiments 1-51 is present in the agricultural composition in an amount sufficient to enhance the biological effect of the agriculturally active compound, such that the total amount of the agriculturally active compound in the agricultural composition that is applied to crops or agricultural produce is lower than would typically be required and/or recommended to provide the same biological effect in a composition that does not comprise the compound of any one of embodiments 1-51.

58. The agricultural composition of embodiment 56 or embodiment 57, wherein the agriculturally active compound is an acaricide, antimicrobial, fungicide, herbicide, insecticide, molluscicide, or nematocide, or a combination thereof.

59. The agricultural composition of embodiment 58, wherein the agriculturally active compound is a fungicide.

60. The agricultural composition of embodiment 58, wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

61. The agricultural composition of embodiment 58, wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridiazole, pentachloronitrobenzene, chlorothalonil, captan, dodine, cyazofamid, polyoxin, fluazinam, flutianil, or a combination thereof.

62. A method of using the agricultural composition of any one of embodiments 54-61, the method comprising applying the agricultural composition to a plant, part of a plant, a seed, soil where a plant is or will be growing, or soil where a seed has been or will be sown.

63. A method for controlling or preventing fungal growth comprising applying the agricultural composition of any one of embodiments 59-61 to a site that has a fungal growth or that is at risk of developing a fungal growth.

64. A method for controlling or preventing fungal growth comprising:
diluting the formulation of any one of embodiments 1-53 with water to form a diluted mixture; and
applying the diluted mixture to a site that has a fungal growth or that is at risk of developing a fungal growth.

65. The method of embodiment 64, wherein the formulation is a formulation according to any one of embodiments 1-53, and diluting the formulation further comprises adding an agriculturally active compound.

66. The method of embodiment 65, wherein adding the agriculturally active compound comprises adding an amount of the agriculturally active compound that is less than an amount of the agriculturally active compound that is recommended for use in the absence of the formulation of any one of embodiments 1-51.

67. The method of embodiment 65 or embodiment 66, wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

68. The method of embodiment 65 or embodiment 66, wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridiazole, pentachloronitrobenzene, chlorothalonil, captan, dodine, cyazofamid, polyoxin, fluazinam, flutianil, or a combination thereof.

69. A use of an agricultural composition of any one of embodiments 54-61, for administration to a plant, part of a plant, a seed, soil where a plant is or will be growing, or soil where a seed has been or will be sown.

70. A use of an agricultural composition of any one of embodiments 54-61, for controlling or preventing fungal growth at a site that has a fungal growth or that is at risk of developing a fungal growth.

71. The formulation of embodiment 1, wherein particles of the first active compound have a volume-weighted median particle size, as measured by light scattering, of less than about 15 microns.

72. The formulation of embodiment 1, wherein particles of the first active compound have a volume-weighted median particle size, as measured by light scattering, of less than about 7 microns.

73. The formulation of embodiment 1, wherein particles of the first active compound have a volume-weighted median particle size, as measured by light scattering, of about 1 micron or less.

74. The formulation of embodiment 1, wherein the pH of the formulation is greater than about 7.

75. The formulation of embodiment 1, wherein the pH of the formulation is greater than about 7.4.

76. The formulation of embodiment 1, wherein the pH of the formulation is greater than about 8.

77. A method for protecting a crop from a pest, comprising applying the formulation of any one of embodiments 1-53 or an agricultural composition of any one of embodiments 54-61 to a plant, part of a plant, a seed, soil where a plant is or will be growing, or soil where a seed has been or will be sown, or a combination thereof.

78. The method of embodiment 77, further comprising applying a pesticide to the site the plant, part of a plant, a seed, soil where a plant is or will be growing, or soil where a seed has been or will be sown, or combination thereof.

79. The method of embodiment 78, wherein the effect of the pesticide is potentiated by the formulation or agricultural composition.

80. The method of embodiment 78, wherein the formulation or agricultural composition has a synergistic effect in combination with the pesticide.

81. The method of any one of embodiments 77-80, wherein the formulation or composition is applied to a site that has a fungal growth or that is at risk of developing a fungal growth.

82. The method of any one of embodiments 78-81, wherein the pesticide comprises a fungicide.

83. The method of embodiment 82, wherein the fungicide comprises Imtrex, Balaya, Amistar, Proline, or a combination thereof.

84. The method of embodiment 82, wherein the fungicide is used to treat tomato plants.

85. The method of embodiment 82, wherein the fungicide is used to treat wheat.

87. The method of embodiment 82, wherein the fungicide is used to treat soybean plants.

In view of the many possible embodiments to which the principles of the disclosed invention may be applied, it should be recognized that the embodiments illustrated throughout the present specification are only preferred examples of the invention and should not be taken as limiting the scope of the invention. Rather, the scope of the invention is defined by the following claims. We therefore claim as our invention all that comes within the scope and spirit of these claims.

### APPENDIX 1

| | | | CHEMICAL OR | | | |
|---|---|---|---|---|---|---|
| | TARGET SITE | GROUP | BIOLOGICAL | COMMON | | FRAC |
| MOA | AND CODE | NAME | GROUP | NAME | COMMENTS | CODE |
| A: | A1 | PA-fungicides | acylalanines | benalaxyl | Resistance and cross resistance | 4 |
| nucleic | RNA polymerase I | (PhenylAmides) | | benalaxyl-M | well known in various | |
| acids | | | | (=kiralaxyl) | Oomycetes but mechanism | |
| metabolism | | | | furalaxyl | unknown. | |
| | | | | metalaxyl | High risk. | |
| | | | | metalaxyl-M | See FRAC Phenylamide | |
| | | | | (=mefenoxam) | Guidelines for resistance | |
| | | | oxazolidinones | oxadixyl | management | |
| | | | butyrolactones | ofurace | | |
| | A2 | hydroxy- | hydroxy-(2-amino-) | bupirimate | Medium risk. Resistance and | 8 |
| | adenosin- | (2-amino-) | pyrimidines | dimethirimol | cross resistance known in | |
| | deaminase | pyrimidines | | ethirimol | powdery mildews. | |
| | | | | | Resistance management | |
| | | | | | required. | |
| | A3 | heteroaromatics | isoxazoles | hymexazole | Resistance not known. | 32 |
| | DNA/RNA synthesis | | isothiazolones | octhilinone | | |
| | (proposed) | | | | | |
| | A4 | carboxylic acids | carboxylic acids | oxolinic acid | Bactericide. Resistance known. | 31 |
| | DNA topoisomerase | | | | Risk in fungi unknown. | |
| | type II (gyrase) | | | | Resistance management | |
| | | | | | required. | |
| | A5 | DHODHI- | phenyl-propanol | ipflufenoquin | Medium to high risk. | 52 |
| | inhibition of | fungicides | | | | |
| | dihydroorotate | | | | | |
| | dehydrogenase | | | | | |
| | within de novo | | | | | |
| | pyrimidine | | | | | |
| | biosynthesis | | | | | |
| B: | B1 | MBC - | benzimidazoles | benomyl | Resistance common in many | 1 |
| Cytoskeleton | tubulin | fungicides | | carbendazim | fungal species. Several target | |
| and motor | polymerization | (Methyl | | fuberidazole | site mutations, mostly | |
| protein | | Benzimidazole | | thiabendazole | E198A/G/K, F200Y in β-tubulin | |
| | | Carbamates) | thiophanates | thiophanate | gene. | |
| | | | | thiophanate-methy | Positive cross resistance | |
| | | | | | between the group members. | |
| | | | | | Negative cross resistance to | |
| | | | | | N-phenyl carbamates. | |
| | | | | | High risk. | |
| | | | | | See FRAC Benzimidazole | |
| | | | | | Guidelines for resistance | |
| | | | | | management. | |
| | B2 | N-phenyl | N-phenyl | diethofencarb | Resistance known. Target site | 10 |
| | tubulin | carbamates | carbamates | | mutation E198K. Negative cross | |
| | polymerization | | | | resistance to benzimidazoles. | |
| | | | | | High risk. | |
| | | | | | Resistance management | |
| | | | | | required. | |
| | B3 | benzamides | toluamides | zoxamide | Low to medium risk. | 22 |
| | tubulin | thiazole | ethylamino-thiazole- | ethaboxam | Resistance management | |
| | polymerization | carboxamide | carboxamide | | required. | |
| | B4 | phenylureas | phenylureas | pencycuron | Resistance not known. | 20 |
| | cell division | | | | | |
| | (unknown site) | | | | | |
| | B5 | benzamides | pyridinylmethyl- | fluopicolide | Resistant isolates detected in | 43 |
| | delocalisation of | | benzamides | fluopimomide | grapevine downy mildew. | |
| | spectrin-like | | | | Medium risk. | |
| | proteins | | | | Resistance management | |
| | | | | | required | |
| | B6 | cyanoacrylates | aminocyanoacrylates | phenamacril | Resistance known in Fusarium | 47 |
| | actin/myosin/fimbrin | | | | graminearum. Target site | |
| | function | | | | mutations in the gene coding for | |
| | | | | | myosin-5 found in lab studies. | |
| | | | | | Medium to high risk | |
| | | | | | Resistance management | |
| | | | | | required. | |
| | | aryl-phenyl- | benzophenone | metrafenone | Less sensitive isolates detected | 50 |
| | | ketones | benzoylpyridine | pyriofenone | in powdery mildews | |
| | | | | | (Blumeria and Sphaerotheca) | |
| | | | | | Medium risk. | |
| | | | | | Resistance management | |
| | | | | | required. | |
| | | | | | Reclassified from U8 in 2018 | |
| | B7 | pyridazine | pyridazine | pyridachlometyl | High risk. | 53 |
| | tubulin dynamics | | | | | |
| | modulator | | | | | |
| C. | C1 | pyrimidinamines | pyrimidinamines | diflumetorim | Resistance not known. | 39 |
| respiration | complex I NADH | pyrazole-MET1 | pyrazole-5- | tolfenpyrad | | |
| | oxido-reductase | | carboxamides | | | |
| | | Quinazoline | quinazoline | fenazaquin | | |
| | C2 | SDHI | phenyl-benzamides | benodanil | Resistance known for several | 7 |
| | complex II: | (Succinate- | | flutolanil | fungal species in field | |
| | succinate- | dehydrogenase | | mepronil | populations and lab mutants. | |
| | dehydrogenase | inhibitors) | phenyl-oxo-ethyl | isofetamid | Target site mutations in sdh | |
| | | | thiophene amide | | gene, e.g. H/Y (or H/L) at 257, | |
| | | | pyridinyl-ethyl- | fluopyram | 267,272 or P225L, dependent | |
| | | | benzamides | | on fungal species. | |
| | | | phenyl-cyclobutyl- | cyclobutrifluram | Resistance management | |
| | | | pyridineamide | | required. | |
| | | | furan-carboxamides | fenfuram | Medium to high risk. | |
| | | | oxathiin- | carboxin | See FRAC SDHI Guidelines | |
| | | | carboxamides | oxycarboxin | for resistance management. | |
| | | | thiazole- | thifluzamide | | |
| | | | carboxamides | | | |
| | | | pyrazole-4- | benzovindiflupyr | | |
| | | | carboxamides | bixafen | | |
| | | | | fluindapyr | | |
| | | | | fluxapyroxad | | |
| | | | | furametpyr | | |
| | | | | inpyrfluxam | | |
| | | | | isopyrazam | | |
| | | | | penflufen | | |
| | | | | penthiopyrad | | |
| | | | | sedaxane | | |
| | | | N-cyclopropyl-N- | isoflucypram | | |
| | | | benzyl-pyrazole- | | | |
| | | | carboxamides | | | |
| | | | N-methoxy-(phenyl- | pydiflumetofen | | |
| | | | ethyl)-pyrazole- | | | |
| | | | carboxamides | | | |
| | | | pyridine- | boscalid | | |
| | | | carboxamides | | | |
| | | | pyrazine- | pyraziflumid | | |
| | | | carboxamides | | | |
| C. | C3 | QoI-fungicides | methoxy-acrylates | azoxystrobin | Resistance known in various | 11 |
| respiration | complex III: | (Quinone outside | | coumoxystrobin | fungal species. Target site | |
| | cytochrome bc 1 | Inhibitors) | | enoxastrobin | mutations in cyt b gene (G143A, | |
| | (ubiquinol oxidase) | | | flufenoxystrobin | F129L) and additional | |
| | at Qo site (cyt b | | | picoxystrobin | mechanisms. | |
| | gene) | | | pyraoxystrobin | Cross resistance shown | |
| | | | methoxy-acetamide | mandestrobin | between all members of the | |
| | | | methoxy-carbamates | pyraclostrobin | Code 11 fungicides. | |
| | | | | pyrametostrobin | High risk. | |
| | | | | triclopyricarb | See FRAC Qol Guidelines | |
| | | | oximino-acetates | kresoxim-methyl | for resistance management. | |
| | | | | trifloxystrobin | | |
| | | | oximino-acetamides | dimoxystrobin | | |
| | | | | fenaminstrobin | | |
| | | | | metominostrobin | | |
| | | | | orysastrobin | | |
| | | | oxazolidine-diones | famoxadone | | |
| | | | dihydro-dioxazines | fluoxastrobin | | |
| | | | imidazolinones | fenamidone | | |
| | | | benzyl-carbamates | pyribencarb | | |
| | | QoI-fungicides | tetrazolinones | metyltetraprole | Resistance not known. Not | 11A |
| | | (Quinone outside | | | cross resistant with Code 11 | |
| | | Inhibitors; | | | fungicides on G143A mutants. | |
| | | Subgroup A) | | | High risk. | |
| | | | | | See FRAC Qol Guidelines | |
| | | | | | for resistance management. | |
| C: | C4 | QiI - fungicides | cyano-imidazole | cyazofamid | Resistance risk unknown but | 21 |
| respiration | complex III: | (Quinone inside | sulfamoyl-triazole | amisulbrom | assumed to be medium to high | |
| (continued) | cytochrome bc1 | Inhibitors) | picolinamides | fenpicoxamid | (mutations at target site known | |
| | (ubiquinone | | | florylpicoxamid | in model organisms). | |
| | reductase) at Qi site | | | | Resistance management | |
| | | | | | required. | |
| | | | | | No spectrum overlap with the | |
| | | | | | Oomycete-fungicides | |
| | | | | | cyazofamid and amisulbrom | |
| | C5 | | dinitrophenyl- | binapacryl | Resistance not known. | 29 |
| | uncouplers of | | crotonates | meptyldinocap | Also acaricidal activity. | |
| | oxidative phos- | | | dinocap | | |
| | phorylation | | 2,6-dinitro-anilines | fluazinam | Low risk. However, resistance | |
| | | | | | claimed in Botrytis in Japan. | |
| | | | (pyr.-hydrazones) | (ferimzone) | Reclassified to U 14 in 2012. | |
| | C6 | organo tin | tri-phenyl tin | fentin acetate | Some resistance cases | 30 |
| | inhibitors of | compounds | compounds | fentin chloride | known. Low to medium risk. | |
| | oxidative phos- | | | fentin hydroxide | | |
| | phorylation, ATP | | | | | |
| | synthase | | | | | |
| | C7 | thiophene- | thiophene- | silthiofam | Resistance reported. Risk low. | 38 |
| | ATP transport | carboxamides | carboxamides | | | |
| | (proposed) | | | | | |
| | C8 | QoSI fungicides | triazolo- | ametoctradin | Not cross resistant to QoI | 45 |
| | complex III: | (Quinone outside | pyrimidylamine | | fungicides. | |
| | cytochrome bc1 | Inhibitor, | | | Resistance risk assumed to | |
| | (ubiquinone | stigmatellin | | | be medium to high | |
| | reductase) at | binding type) | | | (single site inhibitor). | |
| | Qo site, stigmatellin | | | | Resistance management | |
| | binding sub-site | | | | required. | |
| D: | D1 | AP-fungicides | anilino-pyrimidines | cyprodinil | Resistance known in Botrytis | 9 |
| amino acids | methionine | (Anilino- | | mepanipyrim | and Venturia, sporadically in | |
| and protein | biosynthesis | Pyrimidines) | | pyrimethanil | Oculimacula. | |
| [symbol] | (proposed) | | | | Medium risk. | |
| | (cgs gene) | | | | See FRAC Anilinopyrimidine | |
| | | | | | Guidelines | |
| | | | | | for resistance management. | |
| | D2 | enopyranuronic | enopyranuronic acid | blasticidin-S | Low to medium risk. | 23 |
| | protein synthesis | acid antibiotic | antibiotic | | Resistance management | |
| | (ribosome, | | | | required. | |
| | termination step) | | | | | |
| | D3 | hexopyranosyl | hexopyranosyl | kasugamycin | Resistance known in fungal | 24 |
| | protein synthesis | antibiotic | antibiotic | | and bacterial (P. glumae) | |
| | (ribosome, initiation | | | | pathogens. Medium risk. | |
| | step) | | | | Resistance management | |
| | | | | | required. | |
| | D4 | glucopyranosyl | glucopyranosyl | streptomycin | Bactericide. Resistance | 25 |
| | protein synthesis | antibiotic | antibiotic | | known. High risk. | |
| | (ribosome, initiation | | | | Resistance management | |
| | step) | | | | required. | |
| | D5 | tetracycline | tetracycline | oxytetracycline | Bactericide. Resistance | 41 |
| | protein synthesis | antibiotic | antibiotic | | known. High risk. | |
| | (ribosome, | | | | Resistance management | |
| | elongation step) | | | | required. | |
| E: | E1 | aza- | aryloxyquinoline | quinoxyfen | Resistance to quinoxyfen | 13 |
| signal | signal transduction | naphthalenes | quinazolinone | proquinazid | known. | |
| transduction | (mechanism | | | | Medium risk. | |
| | unknown) | | | | Resistance management | |
| | | | | | required. Cross resistance | |
| | | | | | found in Erysiphe (Uncinula) | |
| | | | | | necator but not in Blumeria | |
| | | | | | graminis. | |
| | E2 | PP-fungicides | phenylpyrroles | fenpiclonil | Resistance found sporadically, | 12 |
| | MAP/Histidine- | PhenylPyrroles) | | fludioxonil | mechanism speculative. | |
| | Kinase in osmotic | | | | Low to medium risk. | |
| | signal transduction | | | | Resistance management | |
| | (os-2, HOG1) | | | | required. | |
| | E3 | dicarboximides | dicarboximides | chlozolinate | Resistance common in Botrytis | 2 |
| | MAP/Histidine- | | | dimethachlone | and some other pathogens. | |
| | Kinase in osmotic | | | iprodione | Several mutations in OS-1, | |
| | signal transduction | | | procymidone | mostly 1365S. | |
| | (os-1, Daf1) | | | vinclozolin | Cross resistance common | |
| | | | | | between the group members. | |
| | | | | | Medium to high risk. | |
| | | | | | See FRAC Dicarboximide | |
| | | | | | Guidelines | |
| | | | | | for resistance management | |
| F: | F1 | formerly dicarboximides | | | | |
| lipid | F2 | phosphoro- | phosphoro-thiolates | edifenphos | Resistance known in specific | 6 |
| synthesis or | phospholipid | thiolates | | iprobenfos (IBP) | fungi. | |
| transport/ | biosynthesis, | | | pyrazophos | Low to medium risk. | |
| membrane | methyltransferase | Dithiolanes | dithiolanes | isoprothiolane | Resistance management | |
| integrity | | | | | required if used for risky | |
| or function | | | | | pathogens. | |
| | F3 | AH-fungicides | aromatic | biphenyl | Resistance known in some | 14 |
| | cell peroxidation | (Aromatic | hydrocarbons | chloroneb | fungi. | |
| | (proposed) | Hydrocarbons) | | dicloran | Low to medium risk. | |
| | | (chlorophenyls, | | quintozene (PCNB) | Cross resistance patterns | |
| | | nitroanilines) | | tecnazene (TCNB) | complex due to different | |
| | | | | tolclofos-methyl | activity spectra. | |
| | | heteroaromatics | 1,2,4-thiadiazoles | etridiazole | | |
| | F4 | Carbamates | carbamates | iodocarb | Low to medium risk. | 28 |
| | cell membrane | | | propamocarb | Resistance management | |
| | permeability, fatty | | | prothiocarb | required. | |
| | acids (proposed) | | | | | |
| | F5 | formerly CAA-fungicides | | | | |
| | F6 | formerly Bacillus amyloliquefaciens strains (FRAC Code 44); | | | | |
| | microbial disrupters | reclassified to BM02 in 2020 | | | | |
| | of pathogen cell | | | | | |
| | membranes | | | | | |
| | F7 | formerly extract from Melaleuca alternifolia (tea tree oil) | | | | |
| | cell membrane | and plant oils (eugenol, geraniol, thymol) | | | | |
| | disruption | FRAC Code 46, reclassified to BM01 in 2021 | | | | |
| | F8 | Polyene | amphoteric macrolide | natamycin | Resistance not known. | 48 |
| | ergosterol binding | | antifungal antibiotic | (pimaricin) | Agricultural, food and topical | |
| | | | from Streptomyces | | medical uses. | |
| | | | natalensis or | | | |
| | | | S. chattanoogensis | | | |
| | F9 | OSBPI | piperidinyl-thiazole- | oxathiapiprolin | Resistance risk assumed to be | 49 |
| | lipid homeostasis | oxysterol binding | isoxazolines | fluoxapiprolin | medium to high (single site | |
| | and transfer/storage | protein | | | inhibitor). Resistance | |
| | | homologue | | | management required. | |
| | | inhibition | | | (Previously U15). | |
| | F10 | protein fragment | polypeptide | polypeptide | Resistance not known. | 51 |
| | interaction with lipid | | | ASFBIOF01-02 | | |
| | fraction of the cell | | | | | |
| | membrane, with | | | | | |
| | multiple effects on | | | | | |
| | cell membrane | | | | | |
| | integrity | | | | | |
| G: | G1 | DMI-fungicides | piperazines | triforine | There are big differences in | 3 |
| sterol | C14- demethylase | (DeMethylation | pyridines | pyrifenox | the activity spectra of DMI | |
| biosynthesis | in sterol | Inhibitors) | | pyrisoxazole | fungicides. | |
| in [symbol] | biosynthesis | (SBI: Class I) | pyrimidines | fenarimol | Resistance is known in various | |
| | (erg11/cyp51) | | | nuarimol | fungal species. Several | |
| | | | imidazoles | imazalil | resistance mechanisms are | |
| | | | | oxpoconazole | known incl. target site | |
| | | | | pefurazoate | mutations in cyp51 (erg 11) | |
| | | | | prochloraz | gene, e.g. V136A, Y137F, | |
| | | | | triflumizole | A379G, 1381V; cyp51 | |
| | | | triazoles | azaconazole | promotor; ABC transporters | |
| | | | triazolinthiones | bitertanol | and others. | |
| | | | | bromuconazole | Generally wise to accept that | |
| | | | | cyproconazole | cross resistance is present | |
| | | | | difenoconazole | between DMI fungicides active | |
| | | | | diniconazole | against the same fungus. | |
| | | | | epoxiconazole | DMI fungicides are Sterol | |
| | | | | etaconazole | Biosynthesis Inhibitors (SBIs), | |
| | | | | fenbuconazole | but show no cross resistance | |
| | | | | fluquinconazole | to other SBI classes. | |
| | | | | flusilazole | Medium risk. | |
| | | | | flutriafol | See FRAC SBI Guidelines | |
| | | | | hexaconazole | for resistance management. | |
| | | | | imibenconazole | | |
| | | | | ipconazole | | |
| | | | | mefentrifluconazole | | |
| | | | | metconazole | | |
| | | | | myclobutanil | | |
| | | | | penconazole | | |
| | | | | propiconazole | | |
| | | | | simeconazole | | |
| | | | | tebuconazole | | |
| | | | | tetraconazole | | |
| | | | | triadimefon | | |
| | | | | triadimenol | | |
| | | | | triticonazole | | |
| | | | | prothioconazole | | |
| | G2 | amines | morpholines | aldimorph | Decreased sensitivity for | 5 |
| | Δ¹⁴-reductase | (“morpholines”) | | dodemorph | powdery mildews. | |
| | and Δ⁸→Δ⁷- | (SBI: Class II) | | fenpropimorph | Cross resistance within the | |
| | isomerase | | | tridemorph | group generally found but not | |
| | in sterol | | piperidines | fenpropidin | to other | |
| | biosynthesis | | | piperalin | SBI classes. | |
| | (erg24, erg2) | | spiroketal-amines | spiroxamine | Low to medium risk. | |
| | | | | | See FRAC SBI Guidelines | |
| | | | | | for resistance management | |
| | G3 | KRI fungicides | hydroxyanilides | fenhexamid | Low to medium risk. | 17 |
| | 3-keto reductase, | (KetoReductase | amino-pyrazolinone | fenpyrazamine | Resistance management | |
| | C4- de-methylation | Inhibitors) | | | required. | |
| | (erg27) | (SBI: Class III) | | | | |
| | G4 | (SBI class IV) | thiocarbamates | pyributicarb | Resistance not known, | |
| | squalene-epoxidase | | | | fungicidal and herbicidal | |
| | in sterol | | | | activity. | |
| | biosynthesis | | allylamines | naftifine | Medical fungicides only. | 18 |
| | (erg1) | | | terbinafine | | |
| H: | H3 | Formerly glucopyranosyl | | | reclassified to U18 | 26 |
| cell wall | | antibiotic (validamycin) | | | | |
| biosynthesis | H4 | polyoxins | peptidyl pyrimidine | polyoxin | Resistance known. | 19 |
| | chitin synthase | | nucleoside | | Medium risk. | |
| | | | | | Resistance management | |
| | | | | | required. | |
| | H5 | CAA-fungicides | cinnamic acid amides | dimethomorph | Resistance known in | 40 |
| | cellulose synthase | (Carboxylic Acid | | flumorph | Plasmopara viticola but not in | |
| | | Amides) | | pyrimorph | Phytophthora infestans. | |
| | | | valinamide | benthiavalicarb | Cross resistance between all | |
| | | | carbamates | iprovalicarb | members of the CAA group. | |
| | | | | valifenalate | Low to medium risk. | |
| | | | mandelic acid amides | mandipropamid | See FRAC CAA Guidelines for | |
| | | | | | resistance management. | |
| I: | I1 | MBI-R | isobenzo-furanone | fthalide | Resistance not known. | 16.1 |
| melanin | reductase in | (Melanin | pyrrolo-quinolinone | pyroquilon | | |
| synthesis | melanin | Biosynthesis | triazolobenzo- | tricyclazole | | |
| in cell wall | biosynthesis | Inhibitors- | thiazole | | | |
| | | Reductase) | | | | |
| | I2 | MBI-D | cyclopropane- | carpropamid | Resistance known. | 16.2 |
| | dehydratase in | (Melanin | carboxamide | | Medium risk. | |
| | melanin | Biosynthesis | carboxamide | diclocymet | Resistance management | |
| | biosynthesis | Inhibitors - | propionamide | fenoxanil | required. | |
| | | Dehydratase) | | | | |
| | I3 | MBI-P | trifluoroethyl- | tolprocarb | Resistance not known. | 16.3 |
| | polyketide synthase | (Melanin | carbamate | | Additional activity against | |
| | in melanin | Biosynthesis | | | bacteria and fungi through | |
| | biosynthesis | Inhibitors - | | | induction of host plant defence | |
| | | Polyketide | | | | |
| | | synthase) | | | | |
| P: | P 01 | benzo- | benzo-thiadiazole | acibenzolar- | Resistance not known. | P 01 |
| host plant | salicylate-related | thiadiazole | (BTH) | S-methyl | | |
| defence | | (BTH) | | | | |
| induction | P 02 | benzisothiazole | benzisothiazole | probenazole | Resistance not known. | P 02 |
| | salicylate-related | | | (also antibacterial | | |
| | | | | and antifungal | | |
| | | | | activity) | | |
| | P 03 | thiadiazole- | thiadiazole- | tiadinil | Resistance not known. | P 03 |
| | salicylate-related | carboxamide | carboxamide | isotianil | | |
| | P 04 | natural | polysaccharides | laminarin | Resistance not known. | P 04 |
| | polysaccharide | compound | | | | |
| | elicitors | | | | | |
| | P 05 | plant extract | complex mixture, | extract from | Resistance not known. | P 05 |
| | anthraquinone | | ethanol extract | Reynoutria | | |
| | elicitors | | (anthraquinones, | sachalinensis | | |
| | | | resveratrol) | (giant | | |
| | | | | knotweed) | | |
| | P 06 | microbial | bacterial | Bacillus mycoides | Resistance not known. | P 06 |
| | microbial elicitors | | Bacillus spp. | isolate J | | |
| | | | fungal | cell walls of | | |
| | | | Saccharomyces spp. | Saccharomyces | | |
| | | | | cerevisiae | | |
| | | | | strain LAS117 | | |
| | P 07 | phosphonates | ethyl phosphonates | fosetyl-Al | Few resistance cases | P 07 |
| | phosphonates | | | phosphorous | reported in few | |
| | | | | acid and salts | pathogens. | |
| | | | | | Low risk. | |
| | | | | | Reclassified from U33 in | |
| | | | | | 2018 | |
| | P 08 | isothiazole | isothiazolylmethyl | dichlobentiazox | activates SAR both up- | P 08 |
| | salicylate-related | | ether | | and downstream of SA. | |
| | | | | | Resistance not known. | |
| U: | unknown | cyanoacetamide- | cyanoacetamide- | cymoxanil | Resistance claims described. | 27 |
| Unknown | | oxime | oxime | | Low to medium risk. | |
| mode of | | | | | Resistance management | |
| action | | | | | required. | |
| (U numbers | formerly phosphonates (FRAC code 33), reclassified to P 07 in 2018 | | | | | |
| not appearing | unknown | phthalamic acids | phthalamic acids | tecloftalam | Resistance not known. | 34 |
| in the list | | | | (Bactericide) | | |
| derive from | unknown | benzotriazines | benzotriazines | triazoxide | Resistance not known. | 35 |
| reclassified | unknown | benzene- | benzene- | flusulfamide | Resistance not known. | 36 |
| fungicides) | | sulfonamides | sulphonamides | | | |
| | unknown | pyridazinones | pyridazinones | diclomezine | Resistance not known. | 37 |
| | formerly methasulfocarb (FRAC code 42), reclassified to M 12 in 2018 | | | | | |
| | unknown | phenyl- | phenyl-acetamide | cyflufenamid | Resistance in Sphaerotheca. | U 06 |
| | | acetamide | | | Resistance management | |
| | | | | | required | |
| | cell membrane | guanidines | guanidines | dodine | Resistance known in | U 12 |
| | disruption | | | | Venturia inaequalis. | |
| | (proposed) | | | | Low to medium risk. | |
| | | | | | Resistance management | |
| | | | | | recommended. | |
| | unknown | thiazolidine | cyano-methylene- | flutianil | Resistance in Sphaerotheca an [symbol] | U 13 |
| | | | thiazolidines | | Podosphaera xanthii. | |
| | | | | | Resistance management | |
| | | | | | required. | |
| | unknown | pyrimidinone- | pyrimidinone- | ferimzone | Resistance not known | U 14 |
| | | hydrazones | hydrazones | | (previously C5). | |
| | complex III: | 4-quinolyl- | 4-quinolyl-acetates | tebufloquin | Not cross resistant to QoI. | U 16 |
| | cytochrome bc1, | acetate | | | Resistance risk unknown but | |
| | unknown binding | | | | assumed to be medium. | |
| | site (proposed) | | | | Resistance management | |
| | | | | | required. | |
| | Unknown | tetrazolyloxime | tetrazolyloximes | picarbutrazox | Resistance not known. | U 17 |
| | | | | | Not cross resistant to | |
| | | | | | PA, QoI, CAA. | |
| | Unknown | glucopyranosyl | glucopyranosyl | validamycin | Resistance not known. | U 18 |
| | (Inhibition of | antibiotic | antibiotics | | Induction of host plant defense | |
| | trehalase) | | | | by trehalose proposed | |
| | | | | | (previously H3). | |
| Not specified | Unknown | diverse | diverse | mineral oils, | Resistance not known. | NC |
| | | | | organic oils, | | |
| | | | | inorganic salts, | | |
| | | | | material of | | |
| | | | | biological origin | | |
| M: | multi-site | inorganic | inorganic | copper | Also applies to organic copper | M 01 |
| Chemicals | contact | (electrophiles) | | (different salts) | complexes | |
| with | activity | inorganic | inorganic | sulphur | generally considered as a low | M 02 |
| multi-site | | (electrophiles) | | | risk group without any signs of | |
| [symbol] | | dithiocarbamates | dithio-carbamates | amobam | resistance developing to the | M 03 |
| | | and relatives | and relatives | ferbam | fungicides. | |
| | | (electrophiles) | | mancozeb | | |
| | | | | maneb | | |
| | | | | metiram | | |
| | | | | propineb | | |
| | | | | thiram | | |
| | | | | zinc thiazole | | |
| | | | | zineb | | |
| | | | | ziram | | |
| | | phthalimides | phthalimides | captan | | M 04 |
| | | (electrophiles) | | captafol | | |
| | | | | folpet | | |
| | | chloronitriles | chloronitriles | chlorothalonil | | M 05 |
| | | (phthalonitriles) | (phthalonitriles) | | | |
| | | (unspecified | | | | |
| | | mechanism) | | | | |
| | | sulfamides | sulfamides | dichlofluanid | | M 06 |
| | | (electrophiles) | | tolylfluanid | | |
| | | bis-guanidines | bis-guanidines | guazatine | | M 07 |
| | | (membrane | | iminoctadine | | |
| | | disruptors, | | | | |
| | | detergents) | | | | |
| | | triazines | triazines | anilazine | | M 08 |
| | | (unspecified | | | | |
| | | mechanism) | | | | |
| | | quinones | quinones | dithianon | | M 09 |
| | | (anthraquinones) | (anthraquinones) | | | |
| | | (electrophiles) | | | | |
| | | quinoxalines | quinoxalines | chinomethionat/ | | M 10 |
| | | (electrophiles) | | quinomethionate | | |
| | | maleimide | maleimide | fluoroimide | | M 11 |
| | | (electrophiles) | | | | |
| | | thiocarbamate | thiocarbamate | methasulfocarb | reclassified from U42 in 2018 | M 12 |
| | | (electrophiles) | | | | |
| BM: | multiple effects on | plant extract | polypeptide (lectin) | extract from the | Resistance not known. | BM 01 |
| Biologicals | ion membrane | | | cotyledons of | (previously M12). | |
| with | transporters; | | | lupine plantlets | | |
| multiple | chelating effects | | | (“BLAD”) | | |
| modes | affects fungal | plant extract | phenols, | extract from | Resistance not known. | |
| of action: | spores and germ | | sesquiterpenes, | Swinglea glutinosa | | |
| Plant | tubes, | | triterpenoids, | | | |
| extracts | induced plant | | coumarins | | | |
| | defense | | | | | |
| | cell membrane | plant extract | terpene hydrocarbons, | extract from | Resistance not known. | |
| | disruption, cell wall, | | terpene alcohols and | Melaleuca | (previously F7) | |
| | induced plant | | terpene phenols | alternifolia | | |
| | defense | | | (tea tree oil) | | |
| | mechanisms | | | plant oils | | |
| | | | | (mixtures): | | |
| | | | | eugenol, geraniol, | | |
| | | | | thymol | | |
| BM: | multiple effects | microbial | fungal | T. atroviride | nomenclature change from | BM 02 |
| Biologicals | described | (strains of living | Trichoderma spp. | strain I-1237 | Gliocladium catenulatum to | |
| with | (examples, not all | microbes or | | strain LU132 | Clonostachys rosea | |
| multiple | apply to all | extract, | | strain SC1 | Resistance not known. | |
| modes | biological groups): | metabolites) | | strain SKT-1 | Bacillus amyloliquefaciens | |
| of action: | competition, | | | strain 77B | reclassified from F6, Code 44 | |
| Microbial | mycoparasitism, | | | T. asperellum | in 2020 | |
| (living | antibiosis, | | | strain T34 | synonyms for Bacillus | |
| microbes, | membrane | | | strain kd | amyloliquefaciens are Bacillus | |
| extracts or | disruption by | | | T. harzianum | subtilis and B. subtilis var. | |
| metabolites) | fungicidal | | | strain T-22 | amyloliquefaciens (previous | |
| | lipopeptides, | | | T. virens | taxonomic classification). | |
| | lytic enzymes, | | | strain G-41 | | |
| | induced plant | | fungal | C. rosea | | |
| | defence | | Clonostachys spp. | strain J1446 | | |
| | | | | strain CR-7 | | |
| | | | fungal | C. minitans | | |
| | | | Coniothyrium spp. | strain CON/M/91-08 | | |
| | | | fungal | H. uvarum | | |
| | | | Hanseniaspora spp. | strain BC18Y | | |
| | | | fungal | T. flavus | | |
| | | | Talaromyces spp. | strain SAY-Y-94-01 | | |
| | | | fungal | S. cerevisae | | |
| | | | Saccharomyces spp. | strain LAS02 | | |
| | | | | strain DDSF623 | | |
| | | | bacterial | B. amyloliquefaciens | | |
| | | | Bacillus spp. | strain QST713 | | |
| | | | | strain FZB24 | | |
| | | | | strain MBI600 | | |
| | | | | strain D747 | | |
| | | | | strain F727 | | |
| | | | | strain AT-332 | | |
| | | | | B. subtilis | | |
| | | | | strain AFS032321 | | |
| | | | | strain Y1336 | | |
| | | | | strain HAI-0404 | | |
| | | | bacterial | PHC25279 | | |
| | | | Erwinia spp. | | | |
| | | | (peptide) | | | |
| | | | bacterial | G. cerinus | | |
| | | | Gluconobacter spp. | strain BC18B | | |
| | | | bacterial | P. chlororaphis | | |
| | | | Pseudomonas spp. | strain AFS009 | | |
| | | | bacterial | S. griseovirides | | |
| | | | Streptomyces spp. | strain K61 | | |
| | | | | S. lydicus | | |
| | | | | strain WYEC108 | | |

[symbol]

indicates data missing or illegible when filed

### APPENDIX 2

| MODE OF ACTION | CHEMICAL CLASSIFICATION | ACTIVE |
|---|---|---|
| Inhibition of Acetyl CoA | Cyclohexanediones (DIMs) | Alloxydim |
| Carboxylase | | |
| Inhibition of Acetyl CoA | Cyclohexanediones (DIMs) | Butroxydim |
| Carboxylase | | |
| Inhibition of Acetyl CoA | Cyclohexanediones (DIMs) | Clethodim |
| Carboxylase | | |
| Inhibition of Acetyl CoA | Cyclohexanediones (DIMs) | Cloproxydim |
| Carboxylase | | |
| Inhibition of Acetyl CoA | Cyclohexanediones (DIMs) | Cycloxydim |
| Carboxylase | | |
| Inhibition of Acetyl CoA | Cyclohexanediones (DIMs) | Profoxydim |
| Carboxylase | | |
| Inhibition of Acetyl CoA | Cyclohexanediones (DIMs) | Sethoxydim |
| Carboxylase | | |
| Inhibition of Acetyl CoA | Cyclohexanediones (DIMs) | Tepraloxydim |
| Carboxylase | | |
| Inhibition of Acetyl CoA | Cyclohexanediones (DIMs) | Tralkoxydim |
| Carboxylase | | |
| Inhibition of Acetyl CoA | Aryloxyphenoxy-propionates | Clodinafop-propargyl |
| Carboxylase | (FOPs) | |
| Inhibition of Acetyl CoA | Aryloxyphenoxy-propionates | Clofop |
| Carboxylase | (FOPs) | |
| Inhibition of Acetyl CoA | Aryloxyphenoxy-propionates | Cyhalofop-butyl |
| Carboxylase | (FOPs) | |
| Inhibition of Acetyl CoA | Aryloxyphenoxy-propionates | Diclofop-methyl |
| Carboxylase | (FOPs) | |
| Inhibition of Acetyl CoA | Aryloxyphenoxy-propionates | Fenoxaprop-ethyl |
| Carboxylase | (FOPs) | |
| Inhibition of Acetyl CoA | Aryloxyphenoxy-propionates | Fenthiaprop |
| Carboxylase | (FOPs) | |
| Inhibition of Acetyl CoA | Aryloxyphenoxy-propionates | Fluazifop-butyl |
| Carboxylase | (FOPs) | |
| Inhibition of Acetyl CoA | Aryloxyphenoxy-propionates | Haloxyfop-methyl |
| Carboxylase | (FOPs) | |
| Inhibition of Acetyl CoA | Aryloxyphenoxy-propionates | Isoxapyrifop |
| Carboxylase | (FOPs) | |
| Inhibition of Acetyl CoA | Aryloxyphenoxy-propionates | Metamifop |
| Carboxylase | (FOPs) | |
| Inhibition of Acetyl CoA | Aryloxyphenoxy-propionates | Quizalofop-ethyl |
| Carboxylase | (FOPs) | |
| Inhibition of Acetyl CoA | Phenylpyrazoline | Pinoxaden |
| Carboxylase | | |
| Inhibition of Acetolactate | Pyrimidinyl benzoates | Bispyribac-sodium |
| Synthase | | |
| Inhibition of Acetolactate | Pyrimidinyl benzoates | Pyribenzoxim (prodrug of |
| Synthase | | bispyribac) |
| Inhibition of Acetolactate | Pyrimidinyl benzoates | Pyriftalid |
| Synthase | | |
| Inhibition of Acetolactate | Pyrimidinyl benzoates | Pyriminobac-methyl |
| Synthase | | |
| Inhibition of Acetolactate | Pyrimidinyl benzoates | Pyrithiobac-sodium |
| Synthase | | |
| Inhibition of Acetolactate | Sulfonanilides | Pyrimisulfan |
| Synthase | | |
| Inhibition of Acetolactate | Sulfonanilides | Triafamone |
| Synthase | | |
| Inhibition of Acetolactate | Triazolopyrimidine - Type 1 | Cloransulam-methyl |
| Synthase | | |
| Inhibition of Acetolactate | Triazolopyrimidine - Type 1 | Diclosulam |
| Synthase | | |
| Inhibition of Acetolactate | Triazolopyrimidine - Type 1 | Florasulam |
| Synthase | | |
| Inhibition of Acetolactate | Triazolopyrimidine - Type 1 | Flumetsulam |
| Synthase | | |
| Inhibition of Acetolactate | Triazolopyrimidine - Type 1 | Metosulam |
| Synthase | | |
| Inhibition of Acetolactate | Triazolopyrimidine - Type 2 | Penoxsulam |
| Synthase | | |
| Inhibition of Acetolactate | Triazolopyrimidine - Type 2 | Pyroxsulam |
| Synthase | | |
| Inhibition of Acetolactate | Sulfonylureas | Amidosulfuron |
| Synthase | | |
| Inhibition of Acetolactate | Sulfonylureas | Azimsulfuron |
| Synthase | | |
| Inhibition of Acetolactate | Sulfonylureas | Bensulfuron-methyl |
| Synthase | | |
| Inhibition of Acetolactate | Sulfonylureas | Chlorimuron-ethyl |
| Synthase | | |
| Inhibition of Acetolactate | Sulfonylureas | Chlorsulfuron |
| Synthase | | |
| Inhibition of Acetolactate | Sulfonylureas | Cinosulfuron |
| Synthase | | |
| Inhibition of Acetolactate | Sulfonylureas | Cyclosulfamuron |
| Synthase | | |
| Inhibition of Acetolactate | Sulfonylureas | Ethametsulfuron-methyl |
| Synthase | | |
| Inhibition of Acetolactate | Sulfonylureas | Ethoxysulfuron |
| Synthase | | |
| Inhibition of Acetolactate | Sulfonylureas | Flazasulfuron |
| Synthase | | |
| Inhibition of Acetolactate | Sulfonylureas | Flucetosulfuron |
| Synthase | | |
| Inhibition of Acetolactate | Sulfonylureas | Flupyrsulfuron-methyl-Na |
| Synthase | | |
| Inhibition of Acetolactate | Sulfonylureas | Foramsulfuron |
| Synthase | | |
| Inhibition of Acetolactate | Sulfonylureas | Halosulfuron-methyl |
| Synthase | | |
| Inhibition of Acetolactate | Sulfonylureas | Imazosulfuron |
| Synthase | | |
| Inhibition of Acetolactate | Sulfonylureas | lodosulfuron-methyl-Na |
| Synthase | | |
| Inhibition of Acetolactate | Sulfonylureas | Mesosulfuron-methyl |
| Synthase | | |
| Inhibition of Acetolactate | Sulfonylureas | Metazosulfuron |
| Synthase | | |
| Inhibition of Acetolactate | Sulfonylureas | Metsulfuron-methyl |
| Synthase | | |
| Inhibition of Acetolactate | Sulfonylureas | Nicosulfuron |
| Synthase | | |
| Inhibition of Acetolactate | Sulfonylureas | Orthosulfamuron |
| Synthase | | |
| Inhibition of Acetolactate | Sulfonylureas | Oxasulfuron |
| Synthase | | |
| Inhibition of Acetolactate | Sulfonylureas | Primisulfuron-methyl |
| Synthase | | |
| Inhibition of Acetolactate | Sulfonylureas | Propyrisulfuron |
| Synthase | | |
| Inhibition of Acetolactate | Sulfonylureas | Prosulfuron |
| Synthase | | |
| Inhibition of Acetolactate | Sulfonylureas | Pyrazosulfuron-ethyl |
| Synthase | | |
| Inhibition of Acetolactate | Sulfonylureas | Rimsulfuron |
| Synthase | | |
| Inhibition of Acetolactate | Sulfonylureas | Sulfometuron-methyl |
| Synthase | | |
| Inhibition of Acetolactate | Sulfonylureas | Sulfosulfuron |
| Synthase | | |
| Inhibition of Acetolactate | Sulfonylureas | Triasulfuron |
| Synthase | | |
| Inhibition of Acetolactate | Sulfonylureas | Tribenuron-methyl |
| Synthase | | |
| Inhibition of Acetolactate | Sulfonylureas | Thifensulfuron-methyl |
| Synthase | | |
| Inhibition of Acetolactate | Sulfonylureas | Trifloxysulfuron-Na |
| Synthase | | |
| Inhibition of Acetolactate | Sulfonylureas | Triflusulfuron-methyl |
| Synthase | | |
| Inhibition of Acetolactate | Sulfonylureas | Tritosulfuron |
| Synthase | | |
| Inhibition of Acetolactate | Imidazolinones | Imazamethabenz-methyl |
| Synthase | | |
| Inhibition of Acetolactate | Imidazolinones | Imazamox |
| Synthase | | |
| Inhibition of Acetolactate | Imidazolinones | Imazapic |
| Synthase | | |
| Inhibition of Acetolactate | Imidazolinones | Imazapyr |
| Synthase | | |
| Inhibition of Acetolactate | Imidazolinones | Imazaquin |
| Synthase | | |
| Inhibition of Acetolactate | Imidazolinones | Imazethapyr |
| Synthase | | |
| Inhibition of Acetolactate | Triazolinones | Flucarbazone-Na |
| Synthase | | |
| Inhibition of Acetolactate | Triazolinones | Propoxycarbazone-Na |
| Synthase | | |
| Inhibition of Acetolactate | Triazolinones | Thiencarbazone-methyl |
| Synthase | | |
| Inhbition of Photosynthesis at | Triazines | Atraton |
| PSII - Serine 264 Binders | | |
| Inhbition of Photosynthesis at | Triazines | Atrazine |
| PSII - Serine 264 Binders | | |
| Inhbition of Photosynthesis at | Triazines | Ametryne |
| PSII - Serine 264 Binders | | |
| Inhbition of Photosynthesis at | Triazines | Aziprotryne = aziprotryn |
| PSII - Serine 264 Binders | | |
| Inhbition of Photosynthesis at | Triazines | Chlorazine |
| PSII - Serine 264 Binders | | |
| Inhbition of Photosynthesis at | Triazines | CP 17029 |
| PSII - Serine 264 Binders | | |
| Inhbition of Photosynthesis at | Triazines | Cyanazine |
| PSII - Serine 264 Binders | | |
| Inhbition of Photosynthesis at | Triazines | Cyprazine |
| PSII - Serine 264 Binders | | |
| Inhbition of Photosynthesis at | Triazines | Desmetryne |
| PSII - Serine 264 Binders | | |
| Inhbition of Photosynthesis at | Triazines | Dimethametryn |
| PSII - Serine 264 Binders | | |
| Inhbition of Photosynthesis at | Triazines | Dipropetryn |
| PSII - Serine 264 Binders | | |
| Inhbition of Photosynthesis at | Triazines | Eglinazine-ethyl |
| PSII - Serine 264 Binders | | |
| Inhbition of Photosynthesis at | Triazines | Ipazine |
| PSII - Serine 264 Binders | | |
| Inhbition of Photosynthesis at | Triazines | Methoprotryne = methoprotryn |
| PSII - Serine 264 Binders | | |
| Inhbition of Photosynthesis at | Triazines | procyazine |
| PSII - Serine 264 Binders | | |
| Inhbition of Photosynthesis at | Triazines | Proglinazine-ethyl |
| PSII - Serine 264 Binders | | |
| Inhbition of Photosynthesis at | Triazines | Prometon |
| PSII - Serine 264 Binders | | |
| Inhbition of Photosynthesis at | Triazines | Prometryne |
| PSII - Serine 264 Binders | | |
| Inhbition of Photosynthesis at | Triazines | Propazine |
| PSII - Serine 264 Binders | | |
| Inhbition of Photosynthesis at | Triazines | Sebuthylazine |
| PSII - Serine 264 Binders | | |
| Inhbition of Photosynthesis at | Triazines | Secbumeton |
| PSII - Serine 264 Binders | | |
| Inhbition of Photosynthesis at | Triazines | Simetryne |
| PSII - Serine 264 Binders | | |
| Inhbition of Photosynthesis at | Triazines | Simazine |
| PSII - Serine 264 Binders | | |
| Inhbition of Photosynthesis at | Triazines | Terbumeton |
| PSII - Serine 264 Binders | | |
| Inhbition of Photosynthesis at | Triazines | Terbuthylazine |
| PSII - Serine 264 Binders | | |
| Inhbition of Photosynthesis at | Triazines | Terbutryne |
| PSII - Serine 264 Binders | | |
| Inhbition of Photosynthesis at | Triazines | Trietazine |
| PSII - Serine 264 Binders | | |
| Inhbition of Photosynthesis at | Triazolinone | Amicarbazone |
| PSII - Serine 264 Binders | | |
| Inhbition of Photosynthesis at | Triazinones | Ethiozin |
| PSII - Serine 264 Binders | | |
| Inhbition of Photosynthesis at | Triazinones | Hexazinone |
| PSII - Serine 264 Binders | | |
| Inhbition of Photosynthesis at | Triazinones | Isomethiozin |
| PSII - Serine 264 Binders | | |
| Inhbition of Photosynthesis at | Triazinones | Metamitron |
| PSII - Serine 264 Binders | | |
| Inhbition of Photosynthesis at | Triazinones | Metribuzin |
| PSII - Serine 264 Binders | | |
| Inhbition of Photosynthesis at | Uracils | Bromacil |
| PSII - Serine 264 Binders | | |
| Inhbition of Photosynthesis at | Uracils | Isocil |
| PSII - Serine 264 Binders | | |
| Inhbition of Photosynthesis at | Uracils | Lenacil |
| PSII - Serine 264 Binders | | |
| Inhbition of Photosynthesis at | Uracils | Terbacil |
| PSII - Serine 264 Binders | | |
| Inhbition of Photosynthesis at | Phenlcarbamates | Chlorprocarb |
| PSII - Serine 264 Binders | | |
| Inhbition of Photosynthesis at | Phenlcarbamates | Desmedipham |
| PSII - Serine 264 Binders | | |
| Inhbition of Photosynthesis at | Phenlcarbamates | Phenisopham |
| PSII - Serine 264 Binders | | |
| Inhbition of Photosynthesis at | Phenlcarbamates | Phenmedipham |
| PSII - Serine 264 Binders | | |
| Inhbition of Photosynthesis at | Pyridazinone | Chloridazon (=pyrazon) |
| PSII - Serine 264 Binders | | |
| Inhbition of Photosynthesis at | Pyridazinone | Brompyrazon |
| PSII - Serine 264 Binders | | |
| Inhbition of Photosynthesis at | Ureas | Benzthiazuron |
| PSII - Serine 264 Binders | | |
| Inhbition of Photosynthesis at | Ureas | Bromuron |
| PSII - Serine 264 Binders | | |
| Inhbition of Photosynthesis at | Ureas | Buturon |
| PSII - Serine 264 Binders | | |
| Inhbition of Photosynthesis at | Ureas | Chlorbromuron |
| PSII - Serine 264 Binders | | |
| Inhbition of Photosynthesis at | Ureas | Chlorotoluron |
| PSII - Serine 264 Binders | | |
| Inhbition of Photosynthesis at | Ureas | Chloroxuron |
| PSII - Serine 264 Binders | | |
| Inhbition of Photosynthesis at | Ureas | Difenoxuron |
| PSII - Serine 264 Binders | | |
| Inhbition of Photosynthesis at | Ureas | Dimefuron |
| PSII - Serine 264 Binders | | |
| Inhbition of Photosynthesis at | Ureas | Diuron |
| PSII - Serine 264 Binders | | |
| Inhbition of Photosynthesis at | Ureas | Ethidimuron |
| PSII - Serine 264 Binders | | |
| Inhbition of Photosynthesis at | Ureas | Fenuron |
| PSII - Serine 264 Binders | | |
| Inhbition of Photosynthesis at | Ureas | Fluometuron |
| PSII - Serine 264 Binders | | |
| Inhbition of Photosynthesis at | Ureas | Fluothiuron |
| PSII - Serine 264 Binders | | |
| Inhbition of Photosynthesis at | Ureas | Isoproturon |
| PSII - Serine 264 Binders | | |
| Inhbition of Photosynthesis at | Ureas | Isouron |
| PSII - Serine 264 Binders | | |
| Inhbition of Photosynthesis at | Ureas | Linuron |
| PSII - Serine 264 Binders | | |
| Inhbition of Photosynthesis at | Ureas | Metobenzuron |
| PSII - Serine 264 Binders | | |
| Inhbition of Photosynthesis at | Ureas | Metobromuron |
| PSII - Serine 264 Binders | | |
| Inhbition of Photosynthesis at | Ureas | Methabenzthiazuron |
| PSII - Serine 264 Binders | | |
| Inhbition of Photosynthesis at | Ureas | Metoxuron |
| PSII - Serine 264 Binders | | |
| Inhbition of Photosynthesis at | Ureas | Monolinuron |
| PSII - Serine 264 Binders | | |
| Inhbition of Photosynthesis at | Ureas | Monuron |
| PSII - Serine 264 Binders | | |
| Inhbition of Photosynthesis at | Ureas | Neburon |
| PSII - Serine 264 Binders | | |
| Inhbition of Photosynthesis at | Ureas | Parafluron |
| PSII - Serine 264 Binders | | |
| Inhbition of Photosynthesis at | Ureas | Siduron |
| PSII - Serine 264 Binders | | |
| Inhbition of Photosynthesis at | Ureas | Tebuthiuron |
| PSII - Serine 264 Binders | | |
| Inhbition of Photosynthesis at | Ureas | Thiazafluron |
| PSII - Serine 264 Binders | | |
| Inhbition of Photosynthesis at | Amides | Chloranocryl = dicryl |
| PSII - Serine 264 Binders | | |
| Inhbition of Photosynthesis at | Amides | Pentanochlor |
| PSII - Serine 264 Binders | | |
| Inhbition of Photosynthesis at | Amides | Propanil |
| PSII - Serine 264 Binders | | |
| Inhbition of Photosynthesis at | Nitriles | Bromofenoxim |
| PSII - Histidine 215 Binders | | |
| Inhbition of Photosynthesis at | Nitriles | Bromoxynil |
| PSII - Histidine 215 Binders | | |
| Inhbition of Photosynthesis at | Nitriles | Ioxynil |
| PSII - Histidine 215 Binders | | |
| Inhbition of Photosynthesis at | Phenyl-pyridazines | Pyridate |
| PSII - Histidine 215 Binders | | |
| Inhbition of Photosynthesis at | Benzothiadiazinone | Bentazon |
| PSII - Histidine 215 Binders | | |
| PS I Electron Diversion | Pyridiniums | Cyperquat |
| PS I Electron Diversion | Pyridiniums | Diquat |
| PS I Electron Diversion | Pyridiniums | Morfamquat |
| PS I Electron Diversion | Pyridiniums | Paraquat |
| Inhibition of | Diphenyl ethers | Lactofen |
| Protoporphyrinogen Oxidase | | |
| Inhibition of | Diphenyl ethers | Acifluorfen |
| Protoporphyrinogen Oxidase | | |
| Inhibition of | Diphenyl ethers | Bifenox |
| Protoporphyrinogen Oxidase | | |
| Inhibition of | Diphenyl ethers | Chlornitrofen |
| Protoporphyrinogen Oxidase | | |
| Inhibition of | Diphenyl ethers | Fomesafen |
| Protoporphyrinogen Oxidase | | |
| Inhibition of | Diphenyl ethers | Fluorodifen |
| Protoporphyrinogen Oxidase | | |
| Inhibition of | Diphenyl ethers | Fluoroglycofen-ethyl |
| Protoporphyrinogen Oxidase | | |
| Inhibition of | Diphenyl ethers | Fluoronitrofen |
| Protoporphyrinogen Oxidase | | |
| Inhibition of | Diphenyl ethers | Nitrofen |
| Protoporphyrinogen Oxidase | | |
| Inhibition of | Diphenyl ethers | Oxyfluorfen |
| Protoporphyrinogen Oxidase | | |
| Inhibition of | Diphenyl ethers | Chlomethoxyfen |
| Protoporphyrinogen Oxidase | | |
| Inhibition of | Phenylpyrazoles | Pyraflufen-ethyl |
| Protoporphyrinogen Oxidase | | |
| Inhibition of | N-Phenyl-oxadiazolones | Oxadiargyl |
| Protoporphyrinogen Oxidase | | |
| Inhibition of | N-Phenyl-oxadiazolones | Oxadiazon |
| Protoporphyrinogen Oxidase | | |
| Inhibition of | N-Phenyl-triazolinones | Azafenidin |
| Protoporphyrinogen Oxidase | | |
| Inhibition of | N-Phenyl-triazolinones | Carfentrazone-ethyl |
| Protoporphyrinogen Oxidase | | |
| Inhibition of | N-Phenyl-triazolinones | Sulfentrazone |
| Protoporphyrinogen Oxidase | | |
| Inhibition of | N-Phenyl-imides (procide acitive | Fluthiacet-methyl |
| Protoporphyrinogen Oxidase | form) | |
| Inhibition of | N-Phenyl-imides | Butafenacil |
| Protoporphyrinogen Oxidase | | |
| Inhibition of | N-Phenyl-imides | Saflufenacil |
| Protoporphyrinogen Oxidase | | |
| Inhibition of | N-Phenyl-imides | Pentoxazone |
| Protoporphyrinogen Oxidase | | |
| Inhibition of | N-Phenyl-imides | Chlorphthalim |
| Protoporphyrinogen Oxidase | | |
| Inhibition of | N-Phenyl-imides | Cinidon-ethyl |
| Protoporphyrinogen Oxidase | | |
| Inhibition of | N-Phenyl-imides | Flumiclorac-pentyl |
| Protoporphyrinogen Oxidase | | |
| Inhibition of | N-Phenyl-imides | Flumioxazin |
| Protoporphyrinogen Oxidase | | |
| Inhibition of | N-Phenyl-imides | Flumipropyn |
| Protoporphyrinogen Oxidase | | |
| Inhibition of | N-Phenyl-imides | Trifludimoxazin |
| Protoporphyrinogen Oxidase | | |
| Inhibition of | N-Phenyl-imides | Tiafenacil |
| Protoporphyrinogen Oxidase | | |
| Inhibition of | Other | Pyraclonil |
| Protoporphyrinogen Oxidase | | |
| Inhibition of Phytoene | Phenyl ethers | Beflubutamid |
| Desaturase | | |
| Inhibition of Phytoene | Phenyl ethers | Diflufenican |
| Desaturase | | |
| Inhibition of Phytoene | Phenyl ethers | Picolinafen |
| Desaturase | | |
| Inhibition of Phytoene | N-Phenyl heterocycles | Flurochloridone |
| Desaturase | | |
| Inhibition of Phytoene | N-Phenyl heterocycles | Norflurazon |
| Desaturase | | |
| Inhibition of Phytoene | Diphenyl heterocycles | Fluridone |
| Desaturase | | |
| Inhibition of Phytoene | Diphenyl heterocycles | Flurtamone |
| Desaturase | | |
| Inhibition of Hydroxyphenyl | Triketones | Mesotrione |
| Pyruvate Dioxygenase | | |
| Inhibition of Hydroxyphenyl | Triketones | Sulcotrione |
| Pyruvate Dioxygenase | | |
| Inhibition of Hydroxyphenyl | Triketones | Tembotrione |
| Pyruvate Dioxygenase | | |
| Inhibition of Hydroxyphenyl | Triketones | Tefuryltrione |
| Pyruvate Dioxygenase | | |
| Inhibition of Hydroxyphenyl | Triketones | Bicyclopyrone |
| Pyruvate Dioxygenase | | |
| Inhibition of Hydroxyphenyl | Triketones | Fenquinotrione |
| Pyruvate Dioxygenase | | |
| Inhibition of Hydroxyphenyl | Triketones (procide) | Benzobicyclon |
| Pyruvate Dioxygenase | | |
| Inhibition of Hydroxyphenyl | Pyrazoles (procide) | Benzofenap |
| Pyruvate Dioxygenase | | |
| Inhibition of Hydroxyphenyl | Pyrazoles | Pyrasulfotole |
| Pyruvate Dioxygenase | | |
| Inhibition of Hydroxyphenyl | Pyrazoles | Topramezone |
| Pyruvate Dioxygenase | | |
| Inhibition of Hydroxyphenyl | Pyrazoles (procide) | Pyrazolynate |
| Pyruvate Dioxygenase | | |
| Inhibition of Hydroxyphenyl | Pyrazoles (procide) | Pyrazoxyfen |
| Pyruvate Dioxygenase | | |
| Inhibition of Hydroxyphenyl | Pyrazoles | Tolpyralate |
| Pyruvate Dioxygenase | | |
| Inhibition of Hydroxyphenyl | Isoxazoles | Isoxaflutole |
| Pyruvate Dioxygenase | | |
| Inhibition of Homogentisate | Phenoxypyridazine | Cyclopyrimorate |
| Solanesyltransferase | | |
| Inhibition of Deoxy-D-Xyulose | Isoxazolidinone | Clomazone |
| Phosphate Synthase | | |
| Inhibition of Deoxy-D-Xyulose | Isoxazolidinone | Bixlozone |
| Phosphate Synthase | | |
| Inhibition of Enolpyruvyl | Glycine | Glyphosate |
| Shikimate Phosphate | | |
| Synthase | | |
| Inhibition of Glutamine | Phosphinic acids | Glufosinate-ammonium |
| Synthetase | | |
| Inhibition of Glutamine | Phosphinic acids | Bialaphos/bilanafos |
| Synthetase | | |
| Inhibition of Dihydropteroate | Carbamate | Asulam |
| Synthase | | |
| Inhibition of Microtubule | Dinitroanilines | Benefin = benfluralin |
| Assembly | | |
| Inhibition of Microtubule | Dinitroanilines | Butralin |
| Assembly | | |
| Inhibition of Microtubule | Dinitroanilines | Dinitramine |
| Assembly | | |
| Inhibition of Microtubule | Dinitroanilines | Ethalfluralin |
| Assembly | | |
| Inhibition of Microtubule | Dinitroanilines | Fluchloralin |
| Assembly | | |
| Inhibition of Microtubule | Dinitroanilines | Isopropalin |
| Assembly | | |
| Inhibition of Microtubule | Dinitroanilines | Nitralin |
| Assembly | | |
| Inhibition of Microtubule | Dinitroanilines | Prodiamine |
| Assembly | | |
| Inhibition of Microtubule | Dinitroanilines | Profluralin |
| Assembly | | |
| Inhibition of Microtubule | Dinitroanilines | Oryzalin |
| Assembly | | |
| Inhibition of Microtubule | Dinitroanilines | Pendimethalin |
| Assembly | | |
| Inhibition of Microtubule | Dinitroanilines | Trifluralin |
| Assembly | | |
| Inhibition of Microtubule | Pyridines | Dithiopyr |
| Assembly | | |
| Inhibition of Microtubule | Pyridines | Thiazopyr |
| Assembly | | |
| Inhibition of Microtubule | Phosphoroamidates | Butamifos |
| Assembly | | |
| Inhibition of Microtubule | Phosphoroamidates | DMPA |
| Assembly | | |
| Inhibition of Microtubule | Benzoic acid | Chlorthal-dimethyl = DCPA |
| Assembly | | |
| Inhibition of Microtubule | Benzamides | Propyzamide = pronamide |
| Assembly | | |
| Inhibition of Microtubule | Carbamates | Barban |
| Organization | | |
| Inhibition of Microtubule | Carbamates | Carbetamide |
| Organization | | |
| Inhibition of Microtubule | Carbamates | Chlorbufam |
| Organization | | |
| Inhibition of Microtubule | Carbamates | Chlorpropham |
| Organization | | |
| Inhibition of Microtubule | Carbamates | Propham |
| Organization | | |
| Inhibition of Microtubule | Carbamates | Swep |
| Organization | | |
| Inhibition of Cellulose | Triazolocarboxamide | Flupoxam |
| Synthesis | | |
| Inhibition of Cellulose | Benzamides | Isoxaben |
| Synthesis | | |
| Inhibition of Cellulose | Alkylazines | Triaziflam |
| Synthesis | | |
| Inhibition of Cellulose | Alkylazines | Indaziflam |
| Synthesis | | |
| Inhibition of Cellulose | Nitriles | Dichlobenil |
| Synthesis | | |
| Inhibition of Cellulose | Nitriles | Chlorthiamid |
| Synthesis | | |
| Uncouplers | Dinitrophenols | Dinosam |
| Uncouplers | Dinitrophenols | Dinoseb |
| Uncouplers | Dinitrophenols | DNOC |
| Uncouplers | Dinitrophenols | Dinoterb |
| Uncouplers | Dinitrophenols | Etinofen |
| Uncouplers | Dinitrophenols | Medinoterb |
| Inhibition of Very Long-Chain | Azolyl-carboxamides | Cafenstrole |
| Fatty Acid Synthesis | | |
| Inhibition of Very Long-Chain | Azolyl-carboxamides | Fentrazamide |
| Fatty Acid Synthesis | | |
| Inhibition of Very Long-Chain | Azolyl-carboxamides | Ipfencarbazone |
| Fatty Acid Synthesis | | |
| Inhibition of Very Long-Chain | α-Thioacetamides | Anilofos |
| Fatty Acid Synthesis | | |
| Inhibition of Very Long-Chain | α-Thioacetamides | Piperophos |
| Fatty Acid Synthesis | | |
| Inhibition of Very Long-Chain | Isoxazolines | Pyroxasulfone |
| Fatty Acid Synthesis | | |
| Inhibition of Very Long-Chain | Isoxazolines | Fenoxasulfone |
| Fatty Acid Synthesis | | |
| Inhibition of Very Long-Chain | Oxiranes | Indanofan |
| Fatty Acid Synthesis | | |
| Inhibition of Very Long-Chain | Oxiranes | Tridiphane |
| Fatty Acid Synthesis | | |
| Inhibition of Very Long-Chain | α-Chloroacetamides | Acetochlor |
| Fatty Acid Synthesis | | |
| Inhibition of Very Long-Chain | α-Chloroacetamides | Alachlor |
| Fatty Acid Synthesis | | |
| Inhibition of Very Long-Chain | α-Chloroacetamides | Allidochlor = CDAA |
| Fatty Acid Synthesis | | |
| Inhibition of Very Long-Chain | α-Chloroacetamides | Butachlor |
| Fatty Acid Synthesis | | |
| Inhibition of Very Long-Chain | α-Chloroacetamides | Butenachlor |
| Fatty Acid Synthesis | | |
| Inhibition of Very Long-Chain | α-Chloroacetamides | Delachlor |
| Fatty Acid Synthesis | | |
| Inhibition of Very Long-Chain | α-Chloroacetamides | Diethatyl-ethyl |
| Fatty Acid Synthesis | | |
| Inhibition of Very Long-Chain | α-Chloroacetamides | Dimethachlor |
| Fatty Acid Synthesis | | |
| Inhibition of Very Long-Chain | α-Chloroacetamides | Dimethenamid |
| Fatty Acid Synthesis | | |
| Inhibition of Very Long-Chain | α-Chloroacetamides | Metazachlor |
| Fatty Acid Synthesis | | |
| Inhibition of Very Long-Chain | α-Chloroacetamides | Metolachlor |
| Fatty Acid Synthesis | | |
| Inhibition of Very Long-Chain | α-Chloroacetamides | Pethoxamid |
| Fatty Acid Synthesis | | |
| Inhibition of Very Long-Chain | α-Chloroacetamides | Pretilachlor |
| Fatty Acid Synthesis | | |
| Inhibition of Very Long-Chain | α-Chloroacetamides | Propachlor |
| Fatty Acid Synthesis | | |
| Inhibition of Very Long-Chain | α-Chloroacetamides | Propisochlor |
| Fatty Acid Synthesis | | |
| Inhibition of Very Long-Chain | α-Chloroacetamides | Prynachlor |
| Fatty Acid Synthesis | | |
| Inhibition of Very Long-Chain | α-Chloroacetamides | Thenylchlor |
| Fatty Acid Synthesis | | |
| Inhibition of Very Long-Chain | α-Oxyacetamides | Mefenacet |
| Fatty Acid Synthesis | | |
| Inhibition of Very Long-Chain | α-Oxyacetamides | Flufenacet |
| Fatty Acid Synthesis | | |
| Inhibition of Very Long-Chain | Thiocarbamates | Butylate |
| Fatty Acid Synthesis | | |
| Inhibition of Very Long-Chain | Thiocarbamates | Cycloate |
| Fatty Acid Synthesis | | |
| Inhibition of Very Long-Chain | Thiocarbamates | Dimepiperate |
| Fatty Acid Synthesis | | |
| Inhibition of Very Long-Chain | Thiocarbamates | EPTC |
| Fatty Acid Synthesis | | |
| Inhibition of Very Long-Chain | Thiocarbamates | Esprocarb |
| Fatty Acid Synthesis | | |
| Inhibition of Very Long-Chain | Thiocarbamates | Molinate |
| Fatty Acid Synthesis | | |
| Inhibition of Very Long-Chain | Thiocarbamates | Orbencarb |
| Fatty Acid Synthesis | | |
| Inhibition of Very Long-Chain | Thiocarbamates | Pebulate |
| Fatty Acid Synthesis | | |
| Inhibition of Very Long-Chain | Thiocarbamates | Prosulfocarb |
| Fatty Acid Synthesis | | |
| Inhibition of Very Long-Chain | Thiocarbamates | Thiobencarb (=Benthiocarb) |
| Fatty Acid Synthesis | | |
| Inhibition of Very Long-Chain | Thiocarbamates | Tiocarbazil |
| Fatty Acid Synthesis | | |
| Inhibition of Very Long-Chain | Thiocarbamates | Tri-allate |
| Fatty Acid Synthesis | | |
| Inhibition of Very Long-Chain | Thiocarbamates | Vernolate |
| Fatty Acid Synthesis | | |
| Inhibition of Very Long-Chain | Benzofurans | Benfuresate |
| Fatty Acid Synthesis | | |
| Inhibition of Very Long-Chain | Benzofurans | Ethofumesate |
| Fatty Acid Synthesis | | |
| Auxin Mimics | Pyridine-carboxylates | Picloram |
| Auxin Mimics | Pyridine-carboxylates | Clopyralid |
| Auxin Mimics | Pyridine-carboxylates | Aminopyralid |
| Auxin Mimics | Pyridine-carboxylates | Halauxifen |
| Auxin Mimics | Pyridine-carboxylates | Florpyrauxifen |
| Auxin Mimics | Pyridyloxy-carboxylates | Triclopyr |
| Auxin Mimics | Pyridyloxy-carboxylates | Fluroxypyr |
| Auxin Mimics | Phenoxy-carboxylates | 2,4,5-T |
| Auxin Mimics | Phenoxy-carboxylates | 2,4-D |
| Auxin Mimics | Phenoxy-carboxylates | 2,4-DB |
| Auxin Mimics | Phenoxy-carboxylates | Clomeprop |
| Auxin Mimics | Phenoxy-carboxylates | Dichlorprop |
| Auxin Mimics | Phenoxy-carboxylates | Fenoprop |
| Auxin Mimics | Phenoxy-carboxylates | Mecoprop |
| Auxin Mimics | Phenoxy-carboxylates | MCPA |
| Auxin Mimics | Phenoxy-carboxylates | MCPB |
| Auxin Mimics | Benzoates | Dicamba |
| Auxin Mimics | Benzoates | Chloramben |
| Auxin Mimics | Benzoates | TBA |
| Auxin Mimics | Quinoline-carboxylates | Quinclorac |
| Auxin Mimics | Quinoline-carboxylates | Quinmerac |
| Auxin Mimics | Pyrimidine-carboxylates | Aminocyclopyrachlor |
| Auxin Mimics | Other | Benazolin-ethyl |
| Auxin Mimics | Phenyl carboxylates | Chlorfenac = fenac |
| Auxin Mimics | Phenyl carboxylates | Chlorfenprop |
| Auxin Transport Inhibitor | Aryl-carboxylates | Naptalam |
| Auxin Transport Inhibitor | Aryl-carboxylates | Diflufenzopyr-sodium |
| Inhibition of Fatty Acid | Benzyl ether | Cinmethylin |
| Thioesterase | | |
| Inhibition of Fatty Acid | Benzyl ether | Methiozolin |
| Thioesterase | | |
| Inhibition of Serine-Threonine | Other | Endothal |
| Protein Phosphatase | | |
| Inhibition of Solanesyl | Diphenyl ether | Aclonifen |
| Diphosphate Synthase | | |
| Inhibition of Lycopene | Triazole | Amitrole |
| Cyclase | | |
| Unknown | | Bromobutide |
| Unknown | | Cumyluron |
| Unknown | | Difenzoquat |
| Unknown | | DSMA |
| Unknown | | Dymron = Daimuron |
| Unknown | | Etobenzanid |
| Unknown | Arylaminopropionic acid | Flamprop-m |
| Unknown | | Fosamine |
| Unknown | | Methyldymron |
| Unknown | | Monalide |
| Unknown | | MSMA |
| Unknown | | Oleic acid |
| Unknown | | Oxaziclomefone |
| Unknown | | Pelargonic acid |
| Unknown | | Pyributicarb |
| Unknown | | Quinoclamine |
| Unknown | Acetamides | Diphenamid |
| Unknown | Acetamides | Naproanilide |
| Unknown | Acetamides | Napropamide |
| Unknown | Benzamide | Tebutam |
| Unknown | Phosphorodithioate | Bensulide |
| Unknown | Chlorocarbonic acids | Dalapon |
| Unknown | Chlorocarbonic acids | Flupropanate |
| Unknown | Chlorocarbonic acids | TCA |
| Unknown | Trifluoromethanesulfonanilides | Mefluidide |
| Unknown | Trifluoromethanesulfonanilides | Perfluidone |
| Unknown | | CAMA |
| Unknown | | Cacodylic acid |

### APPENDIX 3

| | Sub-group, class or | |
|---|---|---|
| Main Group and Primary Site of | exemplifying Active | |
| Action | Ingredient | Active Ingredients |
| 1 | 1A | Alanycarb, Aldicarb, Bendiocarb, Benfuracarb, Butocarboxim, |
| Acetylcholinesterase (AChE) | Carbamates | Butoxycarboxim, Carbaryl, Carbofuran, Carbosulfan, |
| inhibitors | | Ethiofencarb, Fenobucarb, Formetanate, Furathiocarb, |
| Nerve action | | Isoprocarb, Methiocarb, Methomyl, Metolcarb, Oxamyl, |
| {Strong evidence that action at this | | Pirimicarb, Propoxur, Thiodicarb, Thiofanox, |
| protein is responsible for insecticidal | | Triazamate, Trimethacarb, XMC, Xylylcarb |
| effects} | 1B | Acephate, Azamethiphos, Azinphos-ethyl, Azinphos- |
| | Organophosphates | methyl, Cadusafos, Chlorethoxyfos, Chlorfenvinphos, |
| | | Chlormephos, Chlorpyrifos, Chlorpyrifos-methyl, |
| | | Coumaphos, Cyanophos, Demeton-S-methyl, Diazinon, |
| | | Dichlorvos/ DDVP, Dicrotophos, Dimethoate, |
| | | Dimethylvinphos, Disulfoton, EPN, Ethion, Ethoprophos, |
| | | Famphur, Fenamiphos, Fenitrothion, Fenthion, |
| | | Fosthiazate, Heptenophos, Imicyafos, Isofenphos, |
| | | Isopropyl O-(methoxyaminothio- phosphoryl) salicylate, |
| | | Isoxathion, Malathion, Mecarbam, Methamidophos, |
| | | Methidathion, Mevinphos, Monocrotophos, Naled, |
| | | Omethoate, Oxydemeton-methyl, Parathion, Parathion- |
| | | methyl, Phenthoate, Phorate, Phosalone, Phosmet, |
| | | Phosphamidon, Phoxim, Pirimiphos- methyl, Profenofos, |
| | | Propetamphos, Prothiofos, Pyraclofos, Pyridaphenthion, |
| | | Quinalphos, Sulfotep, Tebupirimfos, Temephos, Terbufos, |
| | | Tetrachlorvinphos, Thiometon, Triazophos, Trichlorfon, |
| | | Vamidothion |
| 2 | 2A | Chlordane, Endosulfan |
| GABA-gated chloride channel blockers | Cyclodiene | |
| Nerve action | Organochlorines | |
| {Strong evidence that action at this | 2B | Ethiprole, Fipronil |
| protein is responsible for insecticidal | Phenylpyrazoles (Fiproles) | |
| effects} | | |
| 3 | 3A | Acrinathrin, Allethrin, d-cis-trans Allethrin, d- trans Allethrin, |
| Sodium channel modulators | Pyrethroids Pyrethrins | Bifenthrin, Bioallethrin, Bioallethrin S-cyclopentenyl isomer, |
| Nerve action | | Bioresmethrin, Cycloprothrin, Cyfluthrin, beta- Cyfluthrin, |
| {Strong evidence that action at this | | Cyhalothrin, lambda-Cyhalothrin, gamma-Cyhalothrin, |
| protein is responsible for insecticidal | | Cypermethrin, alpha- Cypermethrin, beta-Cypermethrin, |
| effects} | | theta- cypermethrin, zeta-Cypermethrin, Cyphenothrin, |
| | | (1R)-trans- isomers], Deltamethrin, Empenthrin (EZ)- (1R)- |
| | | isomers], Esfenvalerate, Etofenprox, Fenpropathrin, |
| | | Fenvalerate, Flucythrinate, Flumethrin, tau-Fluvalinate, |
| | | Halfenprox, Imiprothrin, Kadethrin, Permethrin, Phenothrin |
| | | [(1R)-trans- isomer], Prallethrin, Pyrethrins (pyrethrum), |
| | | Resmethrin, Silafluofen, Tefluthrin, Tetramethrin, |
| | | Tetramethrin [(1R)-isomers], Tralomethrin, Transfluthrin, |
| | 3B | DDT |
| | DDT | Methoxychlor |
| | Methoxychlor | |
| 4 | 4A | Acetamiprid, Clothianidin, Dinotefuran, |
| Nicotinic acetylcholine receptor | Neonicotinoids | Imidacloprid, Nitenpyram, Thiacloprid, Thiamethoxam, |
| (nAChR) competitive modulators | 4B | Nicotine |
| Nerve action | Nicotine | |
| {Strong evidence that action at one or | 4C | Sulfoxaflor |
| more of this class of protein is | Sulfoximines | |
| responsible for insecticidal effects} | 4D | Flupyradifurone |
| | Butenolides | |
| | 4E | Triflumezopyrim |
| | Mesoionics | |
| | 4F | Flupyrimin |
| | Pyridylidenes | |
| 5 | Spinosyns | Spinetoram, Spinosad |
| Nicotinic acetylcholine receptor | | |
| (nAChR) allosteric modulators Site I | | |
| Nerve action | | |
| {Strong evidence that action at one or | | |
| more of this class of protein is | | |
| responsible for insecticidal effects} | | |
| 6 | Avermectins, | Abamectin, Emamectin benzoate, Lepimectin, Milbemectin |
| Glutamate-gated chloride | Milbemycins | |
| channel (GluCl) allosteric | | |
| modulators | | |
| Nerve and muscle action | | |
| {Strong evidence that action at one or | | |
| more of this class of protein is | | |
| responsible for insecticidal effects} | | |
| 7 | 7A | Hydroprene, Kinoprene, Methoprene |
| Juvenile hormone mimics | Juvenile hormone | |
| Growth regulation | analogues | |
| {Target protein responsible for biological | 7B | Fenoxycarb |
| activity is unknown, or uncharacterized} | Fenoxycarb | |
| | 7C | Pyriproxyfen |
| | Pyriproxyfen | |
| 8* | 8A | Methyl bromide and other alkyl halides |
| Miscellaneous non-specific (multi- | Alkyl halides | |
| site) inhibitors | 8B | Chloropicrin |
| | Chloropicrin | |
| | 8C | Cryolite (Sodium aluminum fluoride), Sulfuryl fluoride |
| | Fluorides | |
| | 8D | Borax, Boric acid, Disodium octaborate, Sodium borate, |
| | Borates | Sodium metaborate |
| | 8E | Tartar emetic |
| | Tartar emetic | |
| | 8F | Dazomet, Metam |
| | Methyl isothiocyanate | |
| | generators | |
| 9 | 9B | Pymetrozine, Pyrifluquinazon |
| Chordotonal organ TRPV | Pyridine azomethine | |
| channel modulators Nerve action | derivatives | |
| {Strong evidence that action at one or | 9D | Afidopyropen |
| more of this class of proteins is | Pyropenes | |
| responsible for insecticidal effects} | | |
| 10 | 10A | Clofentezine, Diflovidazin, Hexythiazox |
| Mite growth inhibitors affecting | Clofentezine Diflovidazin | |
| CHS1 | Hexythiazox | |
| Growth regulation | 10B | Etoxazole |
| {Strong evidence that action at one or | Etoxazole | |
| more of this class of proteins is | | |
| responsible for insecticidal effects} | | |
| 11 | 11A | Bacillus thuringiensis subsp. israelensis Bacillus |
| Microbial disruptors of insect midgut | Bacillus thuringiensis and | thuringiensis subsp. aizawai Bacillus thuringiensis |
| membranes | the insecticidal proteins | subsp. kurstaki Bacillus thuringiensis subsp. |
| (Includes transgenic crops expressing | they produce | tenebrionis |
| Bacillus thuringiensis toxins, however | | B.t. crop proteins: (* Please see footnote) Cry1Ab, Cry1Ac, |
| specific guidance for resistance | | Cry1Fa, Cry1A.105, Cry2Ab, Vip3A, mCry3A, Cry3Ab, |
| management of transgenic crops is not | | Cry3Bb, Cry34Ab1/Cry35Ab1 |
| based on rotation of modes of action) | 11B | Bacillus sphaericus |
| | Bacillus sphaericus | |
| 12 | 12A | Diafenthiuron |
| Inhibitors of mitochondrial ATP | Diafenthiuron | |
| synthase | 12B | Azocyclotin, Cyhexatin, Fenbutatin oxide |
| Energy metabolism | Organotin miticides | |
| {Compounds affect the function of this | 12C | Propargite |
| protein, but it is not clear that this is what | Propargite | |
| leads to biological activity} | 12D | Tetradifon |
| | Tetradifon | |
| 13* | Pyrroles Dinitrophenols | Chlorfenapyr DNOC |
| Uncouplers of oxidative | Sulfluramid | Sulfluramid |
| phosphorylation via disruption of | | |
| the proton gradient | | |
| Energy metabolism | | |
| 14 | Nereistoxin analogues | Bensultap, Cartap hydrochloride, Thiocyclam, |
| Nicotinic acetylcholine receptor | | Thiosultap-sodium |
| (nAChR) channel blockers | | |
| Nerve action | | |
| {Compounds affect the function of this | | |
| protein, but it is not clear that this is what | | |
| leads to biological activity} | | |
| 15 | Benzoylureas | Bistrifluron, Chlorfluazuron, Diflubenzuron, Flucycloxuron, |
| Inhibitors of chitin biosynthesis | | Flufenoxuron, Hexaflumuron, Lufenuron, Novaluron, |
| affecting CHS1 | | Noviflumuron, Teflubenzuron, Triflumuron |
| Growth regulation | | |
| {Strong evidence that action at one or | | |
| more of this class of proteins is | | |
| responsible for insecticidal effects} | | |
| 16 | Buprofezin | Buprofezin |
| Inhibitors of chitin biosynthesis, | | |
| type 1 | | |
| Growth regulation | | |
| {Target protein responsible for biological | | |
| activity is unknown, or uncharacterized} | | |
| 17 | Cyromazine | Cyromazine |
| Moulting disruptors, Dipteran | | |
| Growth regulation | | |
| {Target protein responsible for biological | | |
| activity is unknown, or uncharacterized} | | |
| 18 | Diacylhydrazines | Chromafenozide, Halofenozide, Methoxyfenozide, |
| Ecdysone receptor agonists | | Tebufenozide |
| Growth regulation | | |
| {Strong evidence that action at this | | |
| protein is responsible for insecticidal | | |
| effects} | | |
| 19 | Amitraz | Amitraz |
| Octopamine receptor agonists | | |
| Nerve action | | |
| {Good evidence that action at one or | | |
| more of this class of protein is | | |
| responsible for insecticidal effects} | | |
| 20 | 20A | Hydramethylnon |
| Mitochondrial complex III electron | Hydramethylnon | |
| transport inhibitors - Qo site | 20B | Acequinocyl |
| Energy metabolism | Acequinocyl | |
| {Good evidence that action at this | 20C | Fluacrypyrim |
| protein complex is responsible for | Fluacrypyrim | |
| insecticidal effects} | 20D | Bifenazate |
| | Bifenazate | |
| 21 | 21A | Fenazaquin, Fenpyroximate, Pyridaben, Pyrimidifen, |
| Mitochondrial complex I electron | METI acaricides and | Tebufenpyrad, Tolfenpyrad |
| transport inhibitors | insecticides | |
| Energy metabolism | 21B | Rotenone (Derris) |
| {Good evidence that action at this | Rotenone | |
| protein complex is responsible for | | |
| insecticidal effects} | | |
| 22 | 22A | Indoxacarb |
| Voltage-dependent sodium | Oxadiazines | |
| channel blockers | 22B | Metaflumizone |
| Nerve action | Semicarbazones | |
| {Good evidence that action at this | | |
| protein complex is responsible for | | |
| insecticidal effects} | | |
| 23 | Tetronic and Tetramic acid | Spirodiclofen, Spiromesifen, Spiropidion, Spirotetramat |
| Inhibitors of acetyl CoA carboxylase | derivatives | |
| Lipid synthesis, growth regulation | | |
| {Good evidence that action at this | | |
| protein is responsible for insecticidal | | |
| effects} | | |
| 24 | 24A | Aluminium phosphide, Calcium phosphide, Phosphine, Zinc |
| Mitochondrial complex IV electron | Phosphides | phosphide |
| transport inhibitors | 24B | Calcium cyanide, Potassium cyanide, Sodium cyanide |
| Energy metabolism | Cyanides | |
| {Good evidence that action at this | | |
| protein complex is responsible for | | |
| insecticidal effects} | | |
| 25 | 25A | Cyenopyrafen, Cyflumetofen |
| Mitochondrial complex II electron | Beta-ketonitrile | |
| transport inhibitors | derivatives | |
| Energy metabolism | 25B | Pyflubumide |
| {Good evidence that action at this | Carboxanilides | |
| protein complex is responsible for | | |
| insecticidal effects} | | |
| 28 | Diamides | Chlorantraniliprole, Cyantraniliprole, Cyclaniliprole |
| Ryanodine receptor | | Flubendiamide, Tetraniliprole |
| modulators | | |
| Nerve and muscle action | | |
| {Strong evidence that action at this | | |
| protein complex is responsible for | | |
| insecticidal effects} | | |
| 29 | Flonicamid | Flonicamid |
| Chordotonal organ modulators - | | |
| undefined target site | | |
| Nerve action | | |
| (Modulation of chordotonal organ | | |
| function has been clearly demonstrated, | | |
| but the specific target protein(s) | | |
| responsible for biological activity are | | |
| distinct from Group 9 and remain | | |
| undefined) | | |
| 30 | Meta-diamides Isoxazolines | Broflanilide |
| GABA-gated chloride channel allosteric | | Fluxametamide, Isocyloseram |
| modulators | | |
| Nerve action | | |
| {Strong evidence that action at this | | |
| protein complex is responsible for | | |
| insecticidal effects} | | |
| 31 | Granuloviruses (GVs) | Cydia pomonella GV |
| Baculoviruses | Nucleopolyhedroviruse s | Thaumatotibia leucotreta GV |
| Host-specific occluded | (NPVs) | Anticarsia gemmatalis MNPV |
| pathogenic viruses | | Helicoverpa armigera NPV |
| (Midgut epithelial columnar cell | | |
| membrane target site - undefined) | | |
| 32 | GS-omega/kappa | GS-omega/kappa HXTX-Hv1a peptide |
| Nicotinic Acetylcholine Receptor | HXTX-Hv1a peptide | |
| (nAChR) Allosteric Modulators - Site II | | |
| Nerve action | | |
| {Strong evidence that action at one or | | |
| more of this class of protein is | | |
| responsible for insecticidal effects} | | |
| 33 | Acynonapyr | Acynonapyr |
| Calcium-activated potassium | | |
| channel (KCa2) modulators | | |
| Nerve action | | |
| {Strong evidence that action at this | | |
| protein is responsible for insecticidal | | |
| effects} | | |
| 34 | Flometoquin | Flometoquin |
| Mitochondrial complex III electron | | |
| transport inhibitors - Qi site | | |
| Energy metabolism | | |
| {Modulation of this protein complex has | | |
| been clearly demonstrated and the specific | | |
| target site responsible for biological activity | | |
| is distinct from Group 20} | | |
| UN* | Azadirachtin | Azadirachtin |
| Compounds of unknown or uncertain | Benzoximate | Benzoximate |
| MoA | Benzpyrimoxan | Benzpyrimoxan |
| {Target protein responsible for biological | Bromopropylate | Bromopropylate |
| activity is unknown, or uncharacterized} | Chinomethionat | Chinomethionat |
| | Dicofol | Dicofol |
| | Lime sulfur | Lime sulfur |
| | Mancozeb | Mancozeb |
| | Pyridalyl | Pyridalyl |
| | Sulfur | Sulfur |
| UNB* | | Burkholderia spp |
| Bacterial agents (non-Bt) of unknown or | | Wolbachia pipientis (Zap) |
| uncertain MoA | | |
| {Target protein responsible for biological | | |
| activity is unknown or uncharacterized} | | |
| UNE* | | Chenopodium ambrosioides near ambrosioides |
| Botanical essence including | | extract |
| synthetic, extracts and unrefined | | Fatty acid monoesters with glycerol or propanediol Neem oil |
| oils with unknown or uncertain MoA | | |
| {Target protein responsible for biological | | |
| activity is unknown, or uncharacterized} | | |
| UNF* | | Beauveria bassiana strains |
| Fungal agents of unknown or uncertain | | Metarhizium anisopliae strain F52 |
| MoA | | Paecilomyces fumosoroseus Apopka strain 97 |
| {Target protein responsible for biological | | |
| activity is unknown, or uncharacterized} | | |
| UNM* | | Diatomaceous earth |
| Non-specific mechanical and physical | | Mineral oil |
| disruptors | | |
| {Target protein responsible for biological | | |
| activity is unknown, or uncharacterized} | | |

We claim:

1. A formulation, comprising an aqueous suspension of a first active compound having a structure 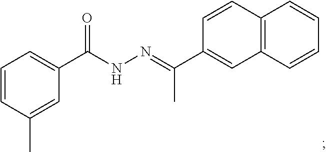 [SMILES: C/C(=N\NC(=O)c1cccc(C)c1)c1ccc2ccccc2c1]
a dispersant;
a freezing point depressant; and
a buffer or partially neutralized base, such that the pH of the formulation is from about 6 to 11;
wherein
particles of the first active compound have a volume-weighted median particle size, as measured by light scattering, of from greater than 0.01 to 20 microns.

2. The formulation of claim 1, wherein the formulation comprises from 0.5 wt % to about 60 wt % of the first active compound.

3. The formulation of claim 1, wherein the formulation comprises from 15 wt % to 40 wt % of the first active compound.

4. The formulation of claim 1, wherein the formulation comprises less than 15 wt % of the first active compound and the formulation further comprises an inert filler, such that the total amount of suspended material in the formulation is at least 10 wt %.

5. The formulation of claim 1, wherein the formulation comprises from 0.1 wt % to 15 wt % of the dispersant.

6. The formulation of claim 1, wherein the formulation comprises from 1 wt % to 10 wt % of the dispersant.

7. The formulation of claim 1, wherein the dispersant has a molecular weight of from 400 Daltons to 2,000,000 Daltons.

8. The formulation of claim 1, wherein the dispersant has a molecular weight of from 1,000 Daltons to 100,000 Daltons.

9. The formulation of claim 1, wherein the dispersant is an anionic dispersant, a cationic dispersant, a non-ionic dispersant, or a combination thereof.

10. The formulation of claim 9, wherein the dispersant is an anionic dispersant.

11. The formulation of claim 9, wherein the dispersant is a nonionic dispersant.

12. The formulation of claim 1, wherein the dispersant is selected from a homo-polymeric dispersant, a random or statistical copolymer, a block copolymer, or a combination thereof.

13. The formulation of claim 1, wherein the dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypopyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

14. The formulation of claim 1, wherein the formulation comprises from greater than zero to 25 wt % of the freezing point depressant.

15. The formulation of claim 1, wherein the formulation comprises from 5 wt % to 20 wt % of the freezing point depressant.

16. The formulation of claim 1, wherein the freezing point depressant is a glycol, sugar, water soluble salt, or a combination thereof.

17. The formulation of claim 16, wherein the sugar has a molecular weight of from 180 Daltons to 1,000 Daltons.

18. The formulation of claim 16, wherein:
the glycol is ethylene glycol, propylene glycol, glycerol, dipropylene glycol, tri-propylene glycol, or a combination thereof;
the sugar is ribose, xylose, glucose, fructose, mannose, sucrose, maltose, isomaltose, trehalose, xylitol, mannitol, sorbitol, dextrose, galactose, lactose, maltodextrin, saccharose, or a combination thereof;
the water soluble salt is a fluoride, chloride, iodide, nitrate, sulfate or phosphate salt of ammonium, lithium, sodium, potassium, magnesium, calcium or aluminum; or
a combination thereof.

19. The formulation of claim 18, wherein the freezing point depressant is propylene glycol.

20. The formulation of claim 1, wherein the freezing point depressant is selected to reduce a freezing point of the formulation to below −5° C.

21. The formulation of claim 1, wherein the buffer or partially neutralized base provides a pH of from 7 to 10.5 of the formulation.

22. The formulation of claim 1, wherein the buffer is a phosphate buffer or a borate buffer.

23. The formulation of claim 1, wherein the volume-weighted median particle size of the first active compound, as measured by light scattering, is less than about 15 microns.

24. The formulation of claim 1, wherein the volume-weighted median particle size of the first active compound, as measured by light scattering, is less than about 7 microns.

25. The formulation of claim 1, wherein the volume-weighted median particle size of the first active compound, as measured by light scattering, is about 1 micron or less.

26. The formulation of claim 1, wherein the formulation further comprises a viscosity modifier.

27. The formulation of claim 1, wherein the formulation further comprises from 0.1 wt % to 10 wt % of a surfactant.

28. The formulation of claim 1, wherein the formulation further comprises an antifoam.

29. The formulation of claim 1, further comprising an agriculturally active compound.

30. The formulation of claim 29, wherein the agriculturally active compound is an acaricide, antimicrobial, fungicide, herbicide, insecticide, molluscicide, or nematocide, or a combination thereof.

31. The formulation of claim 29, wherein the agriculturally active compound is a fungicide.

32. The formulation of claim 31 wherein the agriculturally active compound is a fungicide selected from a benzimidazole fungicide, dicarboximide fungicide, phenylpyrrole fungicide, anilinopyrimidine fungicide, hydroxyanilide fungicide, carboxamide fungicide, phenylamide fungicide, phosphonate fungicide, cinnamic acid fungicide, OSBPI fungicide, triazole carboxamide fungicide, Group 27 fungicide, carbamate fungicide, benzamide fungicide, demethylation-inhibiting fungicide, piperazine fungicide, pyrimidine fungicide imidazole fungicide, triazole fungicide, morpholine fungicide, Group U6 fungicide, Group 50 fungicide, QoI strobilurin fungicide, quinoline fungicide, inorganic fungicide, copper fungicide, sulfur fungicide, lime sulfur fungicide, ethylenebisdithiocarbamate (EBDC) fungicide, EBDC-like fungicide, aromatic hydrocarbon fungicide, chloronitrile fungicide, phthalimide fungicide, guanidine fungicide, QiI fungicide, polyoxin fungicide, Group 29 fungicide, thiazolidine fungicide, or a combination thereof.

33. The formulation of claim 31, wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridiazole, pentachloronitrobenzene, chlorothalonil, captan, dodine, cyazofamid, polyoxin, fluazinam, flutianil, or a combination thereof.

34. An agricultural composition, comprising water and from 0.01 wt % to 10 wt % of the formulation claim 1.

35. The agricultural composition of claim 34, wherein the formulation of claim 1 is present in the agricultural composition in an amount sufficient to enhance the biological effect of the agriculturally active compound, such that the total amount of the agriculturally active compound in the agricultural composition that is applied to crops or agricultural produce is lower than would typically be required and/or recommended to provide the same biological effect in a composition that does not comprise the formulation of claim 1.

36. The agricultural composition of claim 35, wherein the agriculturally active compound is an acaricide, antimicrobial, fungicide, herbicide, insecticide, molluscicide, or nematocide, or a combination thereof.

37. The agricultural composition of claim 35, wherein the agriculturally active compound is a fungicide.

38. A method of using the agricultural composition of claim 34, the method comprising applying the agricultural composition to a plant, part of a plant, a seed, soil where a plant is or will be growing, or soil where a seed has been or will be sown.

39. A method for controlling or preventing fungal growth comprising applying the agricultural composition of claim 34 to a site that has a fungal growth or that is at risk of developing a fungal growth.

40. A method for controlling or preventing fungal growth comprising:
diluting the formulation of claim 1 with water to form a diluted mixture; and
applying the diluted mixture to a site that has a fungal growth or that is at risk of developing a fungal growth.

41. The method of claim 40, further comprising applying a fungicide to the site.

42. The method of claim 40, wherein diluting the formulation further comprises adding an agriculturally active compound.

43. The method of claim 42, wherein adding the agriculturally active compound comprises adding an amount of the agriculturally active compound that is less than an amount of the agriculturally active compound that is recommended for use in the absence of the formulation claim 1.

44. The formulation of claim 1, wherein the pH of the formulation is greater than about 7.4.

45. The formulation of claim 1, wherein the pH of the formulation is greater than about 8.

46. A method for protecting a crop from a pest, comprising applying the formulation of claim 1 or an agricultural composition of claim 34 to a plant, part of a plant, a seed, soil where a plant is or will be growing, or soil where a seed has been or will be sown, or a combination thereof.

47. The method of claim 46, further comprising applying a pesticide to the site the plant, part of a plant, a seed, soil where a plant is or will be growing, or soil where a seed has been or will be sown, or combination thereof.

48. The method of claim 47, wherein the formulation or agricultural composition has a synergistic effect in combination with the pesticide.

49. The method of claim 48, wherein the pesticide comprises a fungicide.

50. The method of claim 49, wherein the fungicide comprises Imtrex, Balaya, Amistar, Proline, or a combination thereof.
